(19) United States
(12) Patent Application Publication
(10) Pub. No.: US 2021/0395552 A1
(43) Pub. Date: Dec. 23, 2021

(54) IMAGE FORMING METHOD

(71) Applicant: FUJIFILM Corporation, Tokyo (JP)

(72) Inventors: Yushi HONGO, Kanagawa (JP); Ryuji SHINOHARA, Kanagawa (JP); Masaharu KAWAI, Kanagawa (JP); Taiga MIZOE, Kanagawa (JP)

(73) Assignee: FUJIFILM Corporation, Tokyo (JP)

(21) Appl. No.: 17/464,654

(22) Filed: Sep. 1, 2021

Related U.S. Application Data
(63) Continuation of application No. PCT/JP2020/007919, filed on Feb. 27, 2020.

(30) Foreign Application Priority Data
Mar. 28, 2019 (JP) 2019-064598

(51) Int. Cl. C09D 11/54; C09D 11/30; B41J 2/01

(52) U.S. Cl. CPC C09D 11/54; B41J 2/01; C09D 11/30

(57) ABSTRACT

An image forming method includes a step of applying a pretreatment liquid containing an aggregating agent (D) and water (E) onto a base material and a step of forming an image by applying an ink containing water (A), a resin (B), and an organic solvent (C) satisfying Expression (1) onto the pretreatment liquid applied onto the base material, in which in a region to which the ink has been applied, C_{C} which is the number of grams of the organic solvent (C) to be applied per area of 1 m² and C_{D} which is the number of grams of the aggregating agent (D) to be applied per area of 1 m² satisfy Expression (2). SP_{B} represents an SP value (MPa^{1/2}) of a main resin in the resin (B), SP_{C} represents an SP value (MPa^{1/2}) of the organic solvent (C), and |SP_{C}−SP_{B}| represents an absolute value of a difference between SP_{C} and SP_{B}.

|SP_{C}−SP_{B}|≤10.0 Expression (1)

0.10≤C_{C}/C_{D}≤2.90 Expression (2)

### CROSS-REFERENCE TO RELATED APPLICATIONS

This application is a Continuation of PCT International Application No. PCT/JP2020/007919 filed on Feb. 27, 2020, which claims priority under 35 U.S.C § 119(a) to Japanese Patent Application No. 2019-064598 filed on Mar. 28, 2019. Each of the above application(s) is hereby expressly incorporated by reference, in its entirety, into the present application.

### BACKGROUND OF THE INVENTION

### 1. Field of the Invention

The present disclosure relates to an image forming method.

### 2. Description of the Related Art

In the related art, various examinations have been conducted on image formation and inks used for image formation.

Further, JP2017-186472A discloses, as an aqueous inkjet ink which has excellent clogging resistance in a head and is capable of forming an image with excellent rub resistance, an aqueous inkjet ink containing a resin, a nitrogen-containing solvent in which a difference in SP value between the resin and the solvent is 3 or less, and water, in which the content of the nitrogen-containing solvent is in a range of 2 to 9 parts by mass with respect to 1 part by mass of the resin, and the content of the organic solvent having a standard boiling point of 280° C. or higher is 3% by mass or less.

Further, JP2004-35863A discloses, as an inkjet ink that is excellent in a continuous injection property, an optical density, bleeding, intercolor bleeding, and a drying time, an inkjet ink that is used in combination with an ink aggregating agent in a case of printing an image and contains at least a coloring material, one or more polymer surfactants, and one or more water-soluble solvents, in which any one of the polymer surfactants and any one of the water-soluble solvents satisfy the following relationships represented by Expressions (1) and (2).

|SP(sol)−SP(SA)|≤2.5 Expression (1)

W(sol)/W(SA)≥5 Expression (2)

[SP (sol) represents the solubility parameter of a water-soluble solvent, SP (SA) represents the solubility parameter of a hydrophobic group portion of a polymer surfactant, W (sol) represents the content (% by mass) of the water-soluble solvent, and W (SA) represents the content (% by mass) of the polymer surfactant.]

### SUMMARY OF THE INVENTION

However, it may be required to suppress image bleeding in an image formed by using an ink. Further, even in a case where image bleeding can be suppressed, image cracking may not be suppressed. Further, even in a case where image cracking can be suppressed, image bleeding may not be suppressed.

An object of one aspect of the present disclosure is to provide an image forming method which enables formation of an image in which image bleeding and image cracking are suppressed.

Specific means for achieving the above-described objects includes the following aspects.

<1> An image forming method comprising: a step of preparing an ink containing water (A), a resin (B), and an organic solvent (C) that satisfies Expression (1); a step of preparing a pretreatment liquid containing an aggregating agent (D) and water (E); a step of applying the pretreatment liquid onto a base material; and a step of forming an image by applying the ink using an ink jet method onto the pretreatment liquid applied onto the base material, in which in a region to which the ink has been applied, in a case where the base material to which the ink has been applied is viewed in a plan view, C_{C} which the number of grams of the organic solvent (C) to be applied per area of 1 m² and C_{D} which is the number of grams of the aggregating agent (D) to be applied per area of 1 m² satisfy Expression (2).

|SP_{C}−SP_{B}|≤10.0 Expression (1)

0.10≤C_{C}/C_{D}≤2.90 Expression (2)

In Expression (1), SP_{B} represents an SP value of a main resin in the resin (B) in a unit of MPa^{1/2}, SP_{C} represents an SP value of the organic solvent (C) in the unit of MPa^{1/2}, and |SP_{C}−SP_{B}| represents an absolute value of a difference between SP_{C} and SP_{B}.

<2> The image forming method according to <1>, in which the aggregating agent (D) contains at least one selected from the group consisting of a polyvalent metal compound, an organic acid, a polyvalent metal salt, and a water-soluble cationic polymer.

<3> The image forming method according to <1> or <2>, in which in a case of the organic solvent (C), |SP_{C}−SP_{B}| is 5.0 or less.

<4> The image forming method according to any one of <1> to <3>, in which the C_{C}/C_{D} in Expression (2) is 0.50 or greater and 2.00 or less.

<5> The image forming method according to any one of <1> to <4>, in which a content of the organic solvent (C) in the ink is in a range of 0.10% by mass to 10.0% by mass with respect to a total amount of the ink.

<6> The image forming method according to any one of <1> to <5>, in which the resin (B) in the ink contains resin particles.

<7> The image forming method according to any one of <1> to <6>, in which a ratio of a content mass of the organic solvent (C) to a content mass of the resin (B) in the ink is 0.02 or greater and 1.00 or less.

<8> The image forming method according to any one of <1> to <7>, in which the ink further contains an organic solvent other than the organic solvent (C).

<9> The image forming method according to any one of <1> to <8>, wherein the base material is an impermeable base material.

<10> The image forming method according to any one of <1> to <9>, further comprising: a determining step A of determining the number of grams of the ink to be applied per area of 1 m²; and a determining step B of determining the number of grams of the pretreatment liquid to be applied per area of 1 m² to be in a range where Expression (2) is satisfied, based on the number of grams of the ink to be applied which has been determined in the determining step A, a proportion of the organic solvent (C) in the ink, and a proportion of the aggregating agent (D) in the pretreatment liquid, in which the step of applying the pretreatment liquid is a step of applying the pretreatment liquid onto the base material based on the number of grams of the pretreatment liquid to be applied which has been determined in the determining step B, and the step of forming an image is a step of forming an image by applying the ink onto the pretreatment liquid applied onto the base material based on the number of grams of the ink to be applied which has been determined in the determining step A.

According to one aspect of the present disclosure, it is possible to provide an image forming method which enables formation of an image in which image bleeding and image cracking are suppressed.

### BRIEF DESCRIPTION OF THE DRAWINGS

FIG. 1 is a view conceptually showing character images used for evaluation of image bleeding in examples.

FIG. 2 is a view for explaining the details of evaluation standards for image bleeding in the examples.

### DESCRIPTION OF THE PREFERRED EMBODIMENTS

In the present disclosure, a numerical range shown using “to” indicates a range including the numerical values described before and after “to” as a lower limit and an upper limit.

In the present disclosure, in a case where a plurality of substances corresponding to respective components in a composition are present, the amount of the respective components in the composition indicates the total amount of the plurality of substances present in the composition unless otherwise specified.

In a numerical range described in a stepwise manner in the present disclosure, an upper limit or a lower limit described in a certain numerical range may be replaced with an upper limit or a lower limit in another numerical range described in a stepwise manner or a value described in an example.

In the present disclosure, the meaning of the term “step” includes not only an independent step but also a step whose intended purpose is achieved even in a case where the step is not clearly distinguished from other steps.

In the present disclosure, a combination of preferred embodiments is a more preferred embodiment.

In the present disclosure, an “image” indicates an entire film to be formed by applying an ink onto a pretreatment liquid, and “formation of an image” and “image formation” respectively indicate formation of a film and film formation.

Therefore, the “image” in the present disclosure is not limited to a film having a tint and may be, for example, a transparent film. Here, the transparency of a film indicates that the transmittance of visible light having a wavelength of 400 nm to 700 nm is 80% or greater (preferably 90% or greater).

Further, the concept of “image” in the present disclosure also includes a solid image.

An image forming method of the present disclosure includes a step of preparing an ink containing water (A), a resin (B), and an organic solvent (C) that satisfies Expression (1) (hereinafter, also referred to as an “ink preparing step”), a step of preparing a pretreatment liquid containing an aggregating agent (D) and water (E) (hereinafter, also referred to as a “pretreatment liquid adding step”), a step of applying the pretreatment liquid onto a base material (hereinafter, also referred to as a “pretreatment liquid adding step”), and a step of forming an image by applying the ink using an ink jet method onto the pretreatment liquid applied onto the base material (hereinafter, also referred to as an “image forming step”), in which in a region to which the ink has been applied in a case where the base material to which the ink has been applied is viewed in a plan view, C_{C} which the number of grams of the organic solvent (C) to be applied per area of 1 m² and C_{D} which is the number of grams of the aggregating agent (D) to be applied per area of 1 m² satisfy Expression (2).

The image forming method of the present disclosure may include other steps as necessary.

|SP_{C}−SP_{B}|≤10.0 Expression (1)

0.10≤C_{C}/C_{D}≤2.90 Expression (2)

In Expression (1), SP_{B} represents an SP value of a main resin in the resin (B) in a unit of MPa^{1/2}, SP_{C} represents an SP value of the organic solvent (C) in the unit of MPa^{1/2}, and |SP_{C}−SP_{B}| represents an absolute value of a difference between SP_{C} and SP_{B}.

In the present disclosure, the term “SP value” simply indicates the SP value in the unit of MPa^{1/2}.

The SP (solubility parameter) value in the present disclosure is a value calculated by the Okitsu method (“Journal of the Adhesion Society of Japan”, written by Toshinao Okitsu, 29(5) (1993)).

Specifically, the SP value is calculated by the following equation. Further, ΔF is a value described in the literatures.

SP value(δ)=ΣΔF(Molar Attraction Constants)/V(molar volume)

Further, in the present disclosure, the “main resin in the resin (B)” indicates a resin having the largest content mass with respect to the entire ink among all the resins contained in the ink.

The number of kinds of the main resins in the resin (B) is not limited to one and may be two or more. For example, in a case where the resin (B) is formed of a resin X, a resin Y, and a resin Z, the content mass of the resin X is the same as the content mass of the resin Y, and the content mass of the resin X and the content mass of the resin Y are respectively greater than the content mass of the resin Z, the main resins in the resin (B) are two kinds of resins, which are the resin X and the resin Y In a case where two or more main resins are present in the resin (B), the organic solvent (C) is an organic solvent which satisfies Expression (1) with respect to all the main resins, has a boiling point of 250° C. or lower, and has a nitrogen atom.

SP_{B} of the main resin is acquired by weight-averaging the SP values of the respective constitutional units constituting the main resin according to the content mass thereof in the main resin.

More specifically, the SP value of the main resin (that is, SP_{B}) is a value acquired as X by substituting the SP value of an i-type (i represents an integer of 1 or greater) constitutional unit in the main resin for Sᵢ and substituting the content mass of the i-type constitutional unit in the main resin for Wᵢ in Mathematical Equation 1.

X=ΣSᵢWᵢ/ΣWᵢ (Mathematical Equation 1)

As the SP value of the constitutional unit, the SP value of the compound for forming the constitutional unit is employed.

For example, the SP value of a resin a formed of a compound A (10% by mass) having an SP value of 15 MPa^{1/2}, a compound B (20% by mass) having an SP value of 18 MPa^{1/2}, and a compound C (70% by mass) having an SP value of 20 MPa^{1/2} as raw materials is acquired by the following equation.

SP value(MPa^{1/2}) of resin a=(15 MPa^{1/2}×10+18 MPa^{1/2}×20+20 MPa^{1/2}×70)/(10+20+70)=19.1 MPa^{1/2}

The constitutional units in the main resin are identified by thermal analysis gas chromatography.

The analysis of the content mass of the constitutional units in the main resin is performed by nuclear magnetic resonance (NMR).

According to the image forming method of the present disclosure, an image in which bleeding (hereinafter, also referred to as “image bleeding”) and cracking (hereinafter, also referred to as “image cracking”) are suppressed can be formed.

The reason why such an effect is exhibited is assumed as follows. However, the image forming method of the present disclosure is not limited to the following reason.

In the image forming method of the present disclosure, an image is formed by applying an ink containing water (A), a resin (B), and an organic solvent (C) onto a pretreatment liquid containing an aggregating agent (D) and water (E) applied onto a base material.

The aggregating agent (D) in the pretreatment liquid is a component for aggregating the components (for example, the resin (B)) in the ink to suppress image bleeding.

Further, since the organic solvent (C) in the ink satisfies Expression (1), the organic solvent (C) is an organic solvent having an affinity for the main resin in the resin (B). Therefore, the organic solvent (C) is considered to have an action of untangling molecular chains of the main resin in the resin (B).

It is considered that the aggregating property of the resin (B) due to the aggregating agent (D) is enhanced on the base material because of the action of the organic solvent (C) described above (that is, the action of untangling the molecular chains of the main resin in the resin (B)).

In the image forming method of the present disclosure, in a region (that is, a region where an image has been formed) to which the ink has been applied in a case where the base material to which the ink has been applied is viewed in a plan view, C_{C} (g/m²) which the number of grams of the organic solvent (C) to be applied per area of 1 m² and C_{D} (g/m²) which is the number of grams of the aggregating agent (D) to be applied per area of 1 m² satisfy Expression (2) (that is, 0.10≤C_{C}/C_{D}≤2.90).

In the image forming method of the present disclosure, it is considered that in a case where the left side of Expression (2) (that is, 0.10≤C_{C}/C_{D}) is satisfied, which generally means that the amount of the organic solvent (C) to be applied is ensured to some extent, the above-described function of the organic solvent (C) is exhibited, the aggregating property of the resin (B) and the like due to the aggregating agent (D) is enhanced on the base material, and thus, the image bleeding is suppressed.

Further, in the image forming method of the present disclosure, in a case where the right side of Expression (2) (that is, C_{C}/C_{D}≤2.90) is satisfied, which generally means that the amount of the organic solvent (C) to be applied is not extremely large, the aggregating agent (D) in the pretreatment liquid applied onto the base material is likely to permeate into the ink applied onto the pretreatment liquid. In this manner, it is considered that since the aggregation of the resin (B) and the like due to the aggregating agent (D) proceeds not only in the region close to the base material but also in the region separated from the base material in the film thickness direction of the image, the film stress of the image is decreased, and thus image cracking caused by the film stress is suppressed.

In the image forming method of the present disclosure, it is considered that in a case where the amount of the organic solvent (C) to be applied is extremely large (specifically, in a case where the right side of Expression (2) (that is, C_{C}/C_{D}≤2.90) is not satisfied), permeation of the aggregating agent (D) may be disturbed due to a large amount of the organic solvent (C) present in the ink even in a case where the aggregating agent (D) in the pretreatment liquid applied onto the base material is intended to permeate into the ink applied onto the pretreatment liquid. It is considered that this phenomenon is caused by the fact that the organic solvent (C) has a hydrophobic property (specifically, Expression (1)) while the aggregating agent (D) has a hydrophilic property. As a result, it is considered that even though the aggregation proceeds in a region close to the base material in the film thickness direction of the image, the aggregation is unlikely to proceed in a region separated from the base material in the film thickness direction of the image, the film stress of the image is increased, and thus image cracking caused by the film stress occurs in some cases.

On the contrary, it is considered that in the image forming method of the present disclosure, since the right side of Expression (2) (that is, C_{C}/C_{D}<2.90) is satisfied, the above-described phenomenon is suppressed, and image cracking caused by the film stress is suppressed.

Hereinafter, each step of the image forming method of the present disclosure will be described.

[Ink Preparing Step]

The ink preparing step is a step of preparing an ink containing water (A), a resin (B), and an organic solvent (C) (hereinafter, also referred to as a “specific ink”).

The step of preparing the ink may be a step of simply preparing the specific ink that has been prepared in advance or a step of preparing the specific ink.

<Water (A)>

The ink contains water (A).

That is, the specific ink is a so-called aqueous ink.

The content of water (A) is preferably 50% by mass or greater and more preferably 60% by mass or greater with respect to the total amount of the specific ink.

The upper limit of the content of water (A) is appropriately determined according to the content of other components. The upper limit of the content of water (A) may be 90% by mass, 80% by mass, or the like.

<Resin (B)>

The specific ink contains the resin (B).

Here, the resin (B) indicates all the resin components contained in the specific ink.

The kind of resin (B) is not particularly limited.

Examples of the resin (B) include an acrylic resin, a polyester resin, a urethane resin, and an olefin resin.

In the present disclosure, the acrylic resin indicates a polymer (a homopolymer or a copolymer) of a raw material monomer containing at least one selected from the group consisting of acrylic acid, a derivative of acrylic acid (such as acrylic acid ester), methacrylic acid, and a derivative of methacrylic acid (such as methacrylic acid ester).

Further, in the present disclosure, the polyester resin indicates a polymer compound having an ester bond in the main chain. Examples of the polyester resin include a polycondensate of polyvalent carboxylic acid (such as dicarboxylic acid) and polyalcohol (such as a diol).

Further, in the present disclosure, the urethane resin indicates a polymer compound having a urethane bond in the main chain.

Further, in the present disclosure, the olefin resin indicates a polymer (a homopolymer or a copolymer) of a raw material monomer containing an olefin. Examples of the olefin resin include a polymer of one kind of olefin, a copolymer of two or more kinds of olefins, and a copolymer of one or more kinds of olefins and one or more kinds of other monomers. Examples of the olefin include an α-olefin having 2 to 30 carbon atoms.

The weight-average molecular weight (Mw) of the resin (B) is preferably in a range of 3000 to 500000, more preferably in a range of 3000 to 200000, still more preferably in a range of 3000 to 100000, even still more preferably in a range of 5000 to 80000, and even still more preferably in a range of 8000 to 60000.

The weight-average molecular weight (Mw) of the acrylic resin is preferably in a range of 3000 to 100000, more preferably in a range of 5000 to 80000, and still more preferably in a range of 8000 to 60000.

The weight-average molecular weight (Mw) of the polyester resin is preferably in a range of 3000 to 200000, more preferably in a range of 4000 to 150000, still more preferably in a range of 5000 to 100000.

The weight-average molecular weight (Mw) of the urethane resin is preferably in a range of 3000 to 500000, more preferably in a range of 4000 to 300000, and still more preferably in a range of 5000 to 200000.

The weight-average molecular weight (Mw) of the olefin resin is preferably in a range of 3000 to 100000, more preferably in a range of 3000 to 50000, and still more preferably in a range of 7000 to 20000.

In the present disclosure, the weight-average molecular weight (Mw) indicates a value measured according to gel permeation chromatography (GPC) unless otherwise specified.

The measurement according to gel permeation chromatography (GPC) is performed using HLC (registered trademark)-8020GPC (manufactured by Tosoh Corporation) as a measuring device, three columns of TSKgel (registered trademark) Super Multipore HZ-H (manufactured by Tosoh Corporation, 4.6 mmID×15 cm), and tetrahydrofuran (THF) as an eluent. Further, the measurement is performed under measurement conditions of a sample concentration of 0.45% by mass, a flow rate of 0.35 ml/min, a sample injection volume of 10 μl, and a measurement temperature of 40° C. using an RI detector.

Further, the calibration curve is prepared using eight samples of “F-40”, “F-20”, “F-4”, “F-1”, “A-5000”, “A-2500”, “A-1000”, and “n-propylbenzene” which are “Standard Samples TSK standard, polystyrene” (manufactured by Tosoh Corporation).

Specific examples of the form of the resin (B) include resin particles which are particles formed of a resin, and a pigment dispersion resin (hereinafter, also referred to as a “dispersant”) for coating at least a part of a pigment to disperse the pigment.

(Resin Particles)

It is preferable that the resin (B) contains at least one kind of resin particles.

In a case where the resin (B) contains resin particles, image bleeding is further suppressed.

In a case where the resin (B) contains resin particles, the resin (B) may further contain at least one pigment dispersion resin.

In a case where the resin (B) contains resin particles, the proportion of the resin particles in the resin (B) is preferably greater than 50% by mass, more preferably 60% by mass or greater, and still more preferably 80% by mass or greater.

The resin particles may contain one or two or more kinds of resins.

It is preferable that the resin particles that may be contained in the resin (B) include the main resin in the resin (B) (that is, the resin having the largest content mass in the resin (B)).

As the resin contained in the resin particles, a water-insoluble resin is preferable, and a water-insoluble acrylic resin is more preferable.

In the present disclosure, the term “water-insoluble” in a water-insoluble resin indicates a property that the amount of a substance to be dissolved in 100 g of water at 25° C. is less than 1.0 g (more preferably less than 0.5 g).

The volume average particle diameter of the resin particles is preferably in a range of 1 nm to 300 nm, more preferably in a range of 3 nm to 200 nm, and still more preferably in a range of 5 nm to 150 nm.

In the present disclosure, the volume average particle diameter indicates a value measured using a laser diffraction scattering particle size distribution analyzer.

As a measuring device, a particle size distribution measuring device “MICROTRAC MT-3300II” (manufactured by Nikkiso Co., Ltd.) is exemplified.

In regard to the resin particles, for example, as an example of particles formed of an acrylic resin, the description in paragraphs 0137 to 0171 of WO2017/163738A and the description in paragraphs 0036 to 0081 of JP2010-077218A may be referred to.

From the viewpoint of improving the adhesiveness of an image to be obtained, the glass transition temperature (Tg) of the resin contained in the resin particles is preferably 100° C. or lower and more preferably 75° C. or lower.

In the present disclosure, the glass transition temperature of the resin indicates a value measured using differential scanning calorimetry (DSC).

Specifically, the glass transition temperature is measured in conformity with the method described in JIS K 7121 (1987) or JIS K 6240 (2011).

The glass transition temperature in the present disclosure is an extrapolated glass transition start temperature (hereinafter, also referred to as Tig).

The method of measuring the glass transition temperature will be described in more detail.

In a case where the glass transition temperature is acquired, the resin is maintained at a temperature lower than the expected glass transition temperature of the resin by approximately 50° C. until the device is stabilized, the resin is heated to a temperature higher than the temperature at which the glass transition is completed by approximately 30° C. at a heating rate of 20° C./min, and a differential thermal analysis (DTA) curve or a DSC curve is created.

The extrapolated glass transition start temperature (Tig), that is, the glass transition temperature in the present specification is acquired as the temperature of the intersection between a straight line obtained by extending the base line on a low temperature side in the DTA curve or the DSC curve onto a high temperature side and a tangent drawn at a point where the gradient of a curve from a step-like change portion of the glass transition is maximized.

Further, in a case where the resin particles contain two or more kinds of resins, the glass transition temperature (Tg) of the resin particles indicates the weighted average value of the glass transition temperatures of the respective resins.

The resin contained in the resin particles has preferably an alicyclic structure or an aromatic ring structure and more preferably an aromatic ring structure.

As the alicyclic structure, an alicyclic hydrocarbon structure having 5 to 10 carbon atoms is preferable, and a cyclohexane ring structure, a dicyclopentanyl ring structure, a dicyclopentenyl ring structure, or an adamantane ring structure is preferable.

As the aromatic ring structure, a naphthalene ring or a benzene ring is preferable, and a benzene ring is more preferable.

The amount of the alicyclic structure or the aromatic ring structure is, for example, preferably in a range of 0.01 mol to 1.5 mol and more preferably in a range of 0.1 mol to 1 mol per 100 g of the resin contained in the resin particles.

From the viewpoint of further improving the dispersibility of the resin particles in water, it is preferable that the resin contained in the resin particles contains an ionic group in the structure.

The ionic group may be an anionic group or a cationic group, but an anionic group is preferable from the viewpoint of ease of introduction.

The anionic group is not particularly limited, but a carboxy group or a sulfo group is preferable, and a sulfo group is more preferable.

The amount of the ionic group is preferably in a range of 0.001 mol to 1.0 mol and more preferably in a range of 0.01 mol to 0.5 mol, for example, per 100 g of the resin contained in the resin particles.

(Pigment Dispersion Resin)

The pigment dispersion resin is not particularly limited, and a known resin dispersant can be used.

Examples of the known resin dispersants include the resin dispersants described in JP5863600B, JP2018-28080A, JP2017-149906A, and JP2016-193981A.

An acrylic resin is preferable as the pigment dispersion resin.

The total content of the resin (B) is preferably in a range of 0.5% by mass to 25.0% by mass, more preferably in a range of 0.5% by mass to 20.0% by mass, still more preferably in a range of 0.5% by mass to 15.0% by mass, even still more preferably in a range of 0.5% by mass to 10.0% by mass, even still more preferably in a range of 1.0% by mass to 8.0% by mass, and even still more preferably in a range of 2.5% by mass to 7.0% by mass with respect to the entire ink.

In a case where the total content of the resin (B) is 0.5% by mass or greater, image bleeding is further suppressed.

In a case where the total content of the resin (B) is 25.0% by mass or less, jetting failure of the ink is further suppressed, and occurrence of streaks in the image due to the jetting failure is further suppressed.

The SP value of the main resin in the resin (B) (that is, SP_{B}) is not particularly limited as long as the SP value satisfies Expression (1).

SP_{B} is preferably in a range of 10.0 to 30.0.

SP_{B} is more preferably 26.0 or less and still more preferably 22.0 or less.

SP_{B} is more preferably 15.0 or greater and still more preferably 18.0 or greater.

<Organic Solvent (C)>

The specific ink contains an organic solvent (C).

The organic solvent (C) is an organic solvent that satisfies Expression (1) (that is, |SP_{C}−SP_{B}|≤10.0).

The specific ink may contain only one or two or more kinds of organic solvents (C).

The organic solvent (C) is not particularly limited as long as the organic solvent satisfies Expression (1) (that is, |SP_{C}−SP_{B}|≤10.0).

The organic solvent (C) can be appropriately selected based on the relationship with the SP value (that is, SP_{B}) of the main resin in the resin (B).

The SP value (that is, SP_{C}) of the organic solvent (C) is preferably in a range of 10.0 to 30.0.

In a case where SP_{C} is 30.0 or less, the rub resistance of the image is further improved. SP_{C} is more preferably 28.0 or less, still more preferably 26.0 or less, and even still more preferably 25.0 or less.

In a case where SP_{C} is 10.0 or greater, the range of selection of the organic solvent (C) is widened. SP_{C} is more preferably 15.0 or greater, still more preferably 17.5 or more, even still more preferably 20.0 or greater, and even still more preferably 23.0 or greater.

As described above, |SP_{C}−SP_{B}| satisfies the expression of “SP_{C}−SP_{B}|≤10.0” (that is, Expression (1)). That is, |SP_{C}−SP_{B}| is 10.0 or less. In this manner, image bleeding is further suppressed.

The lower limit of |SP_{C}−SP_{B}| is not particularly limited. That is, |SP_{C}−SP_{B}| may be 0.

From the viewpoint of further suppressing image bleeding, it is preferable that the organic solvent (C) includes an organic solvent in which |SP_{C}−SP_{B}| is 8.0 or less.

In this case, the proportion of the organic solvent in which |SP_{C}−SP_{B}| is 8.0 or less in the organic solvent (C) is preferably in a range of 50% by mass to 100% by mass, more preferably in a range of 60% by mass to 100% by mass, and still more preferably in a range of 80% by mass to 100% by mass.

From the viewpoint of further suppressing image bleeding, it is preferable that the organic solvent (C) includes an organic solvent in which |SP_{C}−SP_{B}| is 5.0 or less.

In this case, the proportion of the organic solvent in which |SP_{C}−SP_{B}| is 5.0 or less in the organic solvent (C) is preferably in a range of 50% by mass to 100% by mass, more preferably in a range of 60% by mass to 100% by mass, and still more preferably in a range of 80% by mass to 100% by mass.

It is preferable that the organic solvent (C) contains at least one selected from the group consisting of a glycol compound, a glycol monoether compound, a monoalcohol compound having 5 or more carbon atoms, an aminoalcohol compound, and a pyrrolidone compound.

In this case, the total proportion of the glycol monoether compound, the monoalcohol compound having 5 or more carbon atoms, the aminoalcohol compound, and the pyrrolidone compound in the organic solvent (C) is preferably in a range of 50% by mass to 100% by mass, more preferably in a range of 60% by mass to 100% by mass, and still more preferably in a range of 80% by mass to 100% by mass.

From the viewpoint of further suppressing image bleeding, examples of the glycol compound as the organic solvent (C) include dipropylene glycol (DPG) (SP value of 28.1 MPa^{1/2}), 1,2-pentanediol (1,2-PDO) (see examples described below for the SP value), 1,2-hexanediol (1,2-HDO) (see examples described below for the SP value), and 2-ethyl-1,3-hexanediol (SP value of 25.9 MPa^{1/2}).

Examples of the glycol monoether compound as the organic solvent (C) include diethylene glycol monobutyl ether (DEGmBE) (SP value of 21.5 MPa^{1/2}), diethylene glycol monoethyl ether (DEGmEE) (SP value of 22.8 MPa^{1/2}), dipropylene glycol monomethyl ether (DPGmME) (see examples described below for the SP value), ethylene glycol monobutyl ether (SP value of 21.8 MPa^{1/2}), propylene glycol monobutyl ether (PGmBE) (see examples described below for the SP value), ethylene glycol monopropyl ether (SP value of 22.6 MPa^{1/2}), propylene glycol monopropyl ether (PGmPE) (see examples described below for the SP value), propylene glycol monoethyl ether (SP value of 22.5 MPa^{1/2}), propylene glycol monomethyl ether (PGmME) (see examples described below for the SP value), tripropylene glycol monomethyl ether (TPGmME) (SP value of 20.4 MPa^{1/2}), and triethylene glycol monobutyl ether (TEGmBE) (see examples described below for the SP value).

Examples of the monoalcohol compound having 5 or more carbon atoms as the organic solvent (C) include 2-ethyl hexanol (see examples described below for the SP value), 1-octanol (see examples described below for the SP value), 2-octanol (SP value of 20.1 MPa^{1/2}), 2-propyl-1-hexanol (SP value of 19.4 MPa^{1/2}), 1-pentanol (SP value of 21.4 MPa^{1/2}), 1-hexanol (see examples described below for the SP value), and 1-decanol (SP value of 19.2 MPa^{1/2}).

The monoalcohol compound having 5 or more carbon atoms as the organic solvent (C) has preferably 5 to 10 carbon atoms, more preferably 6 to 10 carbon atoms, still more preferably 7 to 10 carbon atoms, and even still more preferably 8 or 9 carbon atoms.

Examples of the aminoalcohol compound as the organic solvent (C) include dimethylaminoethanol (DMAE) (see examples described below for the SP value) and 2-amino-2-methyl-1-propanol (SP value of 25.1 MPa^{1/2}).

Examples of the pyrrolidone compound as the organic solvent (C) include 2-pyrrolidone (SP value of 25.9 MPa^{1/2}), N-methyl-2-pyrrolidone (SP value of 23.6 MPa^{1/2}), and N-ethyl-2-pyrrolidone (SP value of 22.4 MPa^{1/2}).

From the viewpoint of further suppressing image bleeding, it is still more preferable that the organic solvent (C) contains at least one selected from the group consisting of a glycol monoether compound and a monoalcohol compound having 5 or more carbon atoms.

In this case, the total proportion of the glycol monoether compound and the monoalcohol compound having 5 or more carbon atoms in the organic solvent (C) is preferably in a range of 50% by mass to 100% by mass, more preferably in a range of 60% by mass to 100% by mass, and still more preferably in a range of 80% by mass to 100% by mass.

From the viewpoint of further improving the drying properties and the rub resistance of the image, it is preferable that the organic solvent (C) includes an organic solvent having a boiling point of 250° C. or lower.

In this case, the proportion of the organic solvent having a boiling point of 250° C. or lower in the organic solvent (C) is preferably in a range of 50% by mass to 100% by mass, more preferably in a range of 60% by mass to 100% by mass, and still more preferably in a range of 80% by mass to 100% by mass.

Specific examples of the organic solvent having a boiling point of 250° C. or lower include the specific examples described above.

In the present disclosure, the “boiling point” indicates a boiling point at 1 atm (101325 Pa).

From the viewpoint of further improving the drying properties and the rub resistance of the image, the boiling point of the organic solvent having a boiling point of 2500 or lower is preferably 200° C. or lower, more preferably 170° C. or lower, still more preferably 160° C. or lower, and even still more preferably 150° C. or lower.

As the lower limit of the boiling point of the organic solvent a boiling point of 2500 or lower, for example, 100° C., 110° C., 120° C., or 130° C. is preferable.

The content of the organic solvent (C) is preferably in a range of 0.05% by mass to 12.0% by mass with respect to the total amount of the ink.

In a case where the content of the organic solvent (C) is 0.05% by mass or greater, image bleeding is further suppressed. From the viewpoint of further suppressing image bleeding, the content of the organic solvent (C) is more preferably 0.10% by mass or greater, still more preferably 0.50% by mass or greater, and even still more preferably 1.00% by mass or greater.

In a case where the content of the organic solvent (C) is 12.0% by mass or less, image cracking is further suppressed. From the viewpoint of further suppressing image cracking, the content of the organic solvent (C) is more preferably 10.0% by mass or less, still more preferably 7.0% by mass or less, and even still more preferably 5.0% by mass or less.

As one of the more preferred embodiments, an embodiment in which the content of the organic solvent (C) is in a range of 0.10% by mass to 10.0% by mass with respect to the total amount of the ink is exemplified.

The ratio of the content mass of the organic solvent (C) to the content mass of the resin (B) in the specific ink (hereinafter, also referred to as the “content mass ratio [C/B]”) is preferably 0.01 or greater and 2.00 or less.

In a case where the content mass ratio [C/B] is 0.01 or greater, image bleeding is further suppressed.

From the viewpoint of further suppressing image bleeding, the content mass ratio [C/B] is more preferably 0.02 or greater and still more preferably 0.10 or greater.

In a case where the content mass ratio [C/B] is 2.00 or less, image cracking is further suppressed.

The content mass ratio [C/B] is preferably 1.00 or less.

As one of the more preferred embodiments, an embodiment in which the content mass ratio [C/B] is 0.02 or greater and 1.00 or less is exemplified.

<Other Organic Solvents>

The specific ink may contain at least one organic solvent other than the organic solvent (C) (that is, an organic solvent that does not satisfy Expression (1)).

As the organic solvent other than the organic solvent (C) (hereinafter, also referred to as “other organic solvents”), a water-soluble organic solvent is preferable.

In a case where the specific ink contains a water-soluble organic solvent as other organic solvents (E), the jettability of the ink from the ink jet head is further improved.

In the present disclosure, the term “water-soluble” indicates a property that 1 g or greater (preferably 3 g or greater or more preferably 10 g or greater) of a substance is dissolved in 100 g of water at 25° C.

From the viewpoint of further improving the drying properties of the specific ink, the boiling point of other organic solvents is preferably 250° C. or lower.

The boiling point of other organic solvents is preferably 200° C. or lower.

The lower limit of the boiling point of other organic solvents is not particularly limited.

As the lower limit of the boiling point of other organic solvents, for example, 100° C., 110° C., 120° C., or 130° C. is preferable.

From the viewpoint of further improving the jettability of the specific ink, it is preferable that the organic solvent (E) satisfies Expression (E1).

From the viewpoint of further improving the jettability of the specific ink, the SP value of other organic solvents is preferably 30.0 or greater.

The upper limit of the SP value of other organic solvents is not particularly limited. The upper limit of the SP value of other organic solvents may be 50.0, 40.0, or the like.

Further, from the viewpoint of further improving the jettability of the specific ink, it is preferable that at least one organic solvent selected from the group consisting of a glycol compound is preferable as other organic solvents.

Examples of the glycol compound as other organic solvents include propylene glycol (a boiling point of 188° C. and an SP value of 35.1 MPa^{1/2}) and diethylene glycol (a boiling point of 245° C. and an SP value of 32.3 MPa^{1/2}).

Further, even the compound exemplified as the glycol compound as the organic solvent (C) described above may correspond to the glycol compound as other organic solvents depending on the SP value of the main resin in the resin (B).

Further, in a case where the specific ink contains other organic solvents, the total content of other organic solvents is preferably in a range of 5% by mass to 40% by mass with respect to the total amount of the ink.

In a case where the total content of other organic solvents is 5% by mass or greater, the jettability of the ink is further improved. From the viewpoint of further improving the jettability of the ink, the total content of other organic solvents is more preferably 10% by mass or greater, still more preferably 15% by mass or greater, and even still more preferably 20% by mass or greater.

In a case where the total content of other organic solvents is 40% by mass or less, the drying properties of the image are further improved. From the viewpoint of further improving the drying properties of the image, the total content of other organic solvents is more preferably 35% by mass or less and still more preferably 30% by mass or less.

<Colorant>

The specific ink may further contain a colorant.

Examples of the colorant include an organic pigment, an inorganic pigment, and a dye.

Examples of the organic pigment include an azo pigment, a polycyclic pigment, a chelate dye, a nitro pigment, a nitroso pigment, and aniline black.

Examples of the inorganic pigment include a white inorganic pigment, iron oxide, barium yellow, cadmium red, chrome yellow, and carbon black.

Preferred examples of the colorant include the colorants described in paragraphs 0096 to 0100 of JP2009-241586A.

It is preferable that the colorant contains a white inorganic pigment. The ink in this case can be suitably used as, for example, a white ink. Further, in a case where the ink contains, as the colorant, a white inorganic pigment and a pigment of a color other than white, the ink can also be used as an ink in which a chromatic tint is added to the white color.

Examples of the white inorganic pigment include titanium dioxide (TiO₂), barium sulfate, calcium carbonate, aluminum hydroxide, silica, zinc oxide, zinc sulfide, mica, talc, and pearl. Among the examples of the white inorganic pigment, titanium dioxide, barium sulfate, calcium carbonate, or zinc oxide is preferable, and titanium dioxide is more preferable.

The ink containing a white inorganic pigment is required to have a property of covering a base (for example, an impermeable base material or a chromatic image recorded on an impermeable base material) (hereinafter, also referred to as a “covering property”) using an image formed of the ink (for example, a white image).

In some cases, a white inorganic pigment having a large particle diameter (for example, having an average primary particle diameter of 150 nm or greater) is selected as the white inorganic pigment in order to enhance the covering property, and the content of the white inorganic pigment in the ink is set to be large (for example, 3% by mass or greater).

In such a case, the resin (B) in the ink may be required to have a higher film-forming property in order for film formation using the ink for each pigment.

The specific ink also satisfies such a requirement.

The average primary particle diameter of the white inorganic pigment is, for example, in a range of 150 nm to 400 nm.

In a case where the average primary particle diameter thereof is 150 nm or greater, the covering property is further improved. Further, in a case where the average primary particle diameter thereof is 400 nm or less, the jettability of the ink is further improved.

The average primary particle diameter of the white inorganic pigment is preferably in a range of 250 nm to 350 nm and more preferably in a range of 250 nm to 300 nm.

The average primary particle diameter of the white inorganic pigment is a value measured using a transmission electron microscope (TEM). A transmission electron microscope 1200EX (manufactured by JEOL Ltd.) can be used for the measurement.

Specifically, the average primary particle diameter is defined as a value obtained by adding the ink diluted to 1000 times dropwise to Cu200 mesh (manufactured by JEOL Ltd.) to which a carbon film has been attached, drying the ink, measuring the equivalent circle diameters of 300 independent particles that do not overlap each other in the image enlarged at a magnification of 100000 times using a TEM, and simply averaging the measured values.

The content of the white inorganic pigment is preferably in a range of 1% by mass to 20% by mass, more preferably in a range of 3% by mass to 17% by mass, and still more preferably in a range of 5% by mass to 15% by mass with respect to the total amount of the ink.

In a case where the content of the white inorganic pigment is 1% by mass or greater, the covering property is further improved.

Further, in a case where the content of the white inorganic pigment is 20% by mass or less, the rub resistance of the image is further improved.

<Other Components>

The specific ink may contain components other than the components described above.

Examples of other components include a surfactant, a wax, a fading inhibitor, an emulsion stabilizer, a penetration enhancer, an ultraviolet absorbing agent, a preservative, a fungicide, a pH adjuster (a neutralizing agent such as an organic base or inorganic alkali), an antifoaming agent, a viscosity adjuster, a dispersion stabilizer, a rust inhibitor, and a chelating agent.

<Preferable Physical Properties of Specific Ink>

The viscosity of the specific ink is preferably 1.2 mPa·s or greater and 15.0 mPa·s or less, more preferably 2 mPa·s or greater and less than 13 mPa·s, and still more preferably 2.5 mPa·s or greater and less than 10 mPa·s.

The viscosity is a value measured at 25° C. using a viscometer.

As the viscometer, for example, a VISCOMETER TV-22 type viscometer (manufactured by Toki Sangyo Co., Ltd.) can be used.

The surface tension of the specific ink is preferably 25 mN/m or greater and 40 mN/m or less and more preferably 27 mN/m or greater and 37 mN/m or less.

The surface tension is a value measured at a temperature of 25° C.

The surface tension can be measured using, for example, an Automatic Surface Tentiometer CBVP-Z (manufactured by Kyowa Interface Science Co., Ltd.).

From the viewpoint of the dispersion stability, the pH of the specific ink at 25° C. is preferably in a range of 6 to 11, more preferably in a range of 7 to 10, and still more preferably in a range of 7 to 9.

The pH of the ink at 25° C. is measured using a commercially available pH meter.

<Pretreatment Liquid Preparing Step>

The pretreatment liquid preparing step is a step of preparing the pretreatment liquid containing the aggregating agent (D) and water (E).

The pretreatment liquid preparing step may be a step of simply preparing the pretreatment liquid that has been prepared in advance or a step of preparing the pretreatment liquid.

<Aggregating Agent (D)>

The pretreatment liquid contains at least one aggregating agent (D).

The aggregating agent (D) is a component that aggregates the components in the specific ink.

As the aggregating agent (D), at least one selected from the group consisting of a polyvalent metal compound, an organic acid, a metal complex, and a water-soluble cationic polymer is preferable.

Polyvalent Metal Compound

Examples of the polyvalent metal compound include alkaline earth metals of a group 2 (such as magnesium and calcium) in the periodic table, transition metals of a group 3 (such as lanthanum) in the periodic table, cations of a group 13 (such as aluminum) in the periodic table, and salts of lanthanides (such as neodymium).

As salts of these metals, salts of organic acids, a nitrate, a chloride, and a thiocyanate described below are suitable.

Among these, a calcium salt or magnesium salt of an organic acid (such as formic acid, acetic acid, or a benzoate), a calcium salt or magnesium salt of nitric acid, calcium chloride, magnesium chloride, and a calcium salt or magnesium salt of thiocyanic acid are preferable.

Further, it is preferable that at least a part of the polyvalent metal compound is dissociated into polyvalent metal ions and counter ions in the pretreatment liquid.

Organic Acid

As the organic acid, an organic compound containing an acidic group is exemplified.

Examples of the acidic group include a phosphoric acid group, a phosphonic acid group, a phosphinic acid group, a sulfuric acid group, a sulfonic acid group, a sulfinic acid group, and a carboxy group.

From the viewpoint of the aggregation rate of the ink, a phosphoric acid group or a carboxy group is preferable, and a carboxy group is more preferable as the acidic group.

Further, it is preferable that at least a part of the acidic group is dissociated in the pretreatment liquid.

Preferred examples of the organic compound containing a carboxy group include polyacrylic acid, acetic acid, formic acid, benzoic acid, glycolic acid, malonic acid, malic acid (preferably DL-malic acid), maleic acid, succinic acid, glutaric acid, fumaric acid, citric acid, tartaric acid, phthalic acid, 4-methylphthalic acid, lactic acid, pyrrolidone carboxylic acid, pyrrone carboxylic acid, pyrrole carboxylic acid, furan carboxylic acid, pyridine carboxylic acid, coumaric acid, thiophene carboxylic acid, and nicotinic acid. These compounds may be used alone or in combination of two or more kinds thereof.

From the viewpoint of the aggregation rate of the ink, as the organic compound containing a carboxy group, a di- or higher valent carboxylic acid (hereinafter, also referred to as a polyvalent carboxylic acid) is preferable.

As the polyvalent carboxylic acid, malonic acid, malic acid, maleic acid, succinic acid, glutaric acid, fumaric acid, tartaric acid, 4-methylphthalic acid, or citric acid is preferable, and malonic acid, malic acid, tartaric acid, glutaric acid, or citric acid is more preferable.

It is preferable that the organic acid has a low pKa (for example, 1.0 to 5.0).

In this manner, the surface charge of particles such as polymer particles or the pigment stably dispersed in the ink by a weakly acidic functional group such as a carboxy group is reduced by bringing the ink into contact with an organic acidic compound having a lower pKa to degrade the dispersion stability.

It is preferable that the organic acid has a low pKa and a high solubility in water and is di- or higher valent and more preferable that the organic acid is a di- or trivalent acidic substance which has a high buffer capacity in a pH region whose pKa is lower than the pKa of the functional group (for example, a carboxy group) that allows the particles to be stably dispersed in the ink.

Metal Complex

As the metal complex, a metal complex including at least one selected from the group consisting of zirconium, aluminum, and titanium as a metallic element is preferable.

As the metal complex, a metal complex including at least one selected from the group consisting of acetate, acetylacetonate, methylacetoacetate, ethylacetoacetate, octylene glycolate, butoxyacetylacetonate, lactate, lactate ammonium salt, and triethanol aminate as a ligand is preferable.

As the metal complex, various metal complexes are commercially available, and a commercially available metal complex may be used in the present disclosure. Further, various organic ligands, particularly various multidentate ligands that are capable of forming metal chelate catalysts are commercially available. Accordingly, a metal complex prepared by combining a commercially available organic ligand with a metal may be used.

Water-Soluble Cationic Polymer

Examples of the water-soluble cationic polymer include polyallylamine, polyallylamine derivatives, poly-2-hydroxypropyldimethylammonium chloride, and poly(diallyldimethylammonium chloride).

The water-soluble cationic polymer can refer to the descriptions in known documents such as JP2011-042150A (particularly, paragraph 0156) and JP2007-98610A (particularly, paragraphs 0096 to 0108) as appropriate.

Examples of commercially available products of the water-soluble cationic polymer include SHALLOL (registered trademark) DC-303P and SHALLOL DC-902P (both manufactured by DKS Co., Ltd.), CATIOMASTER (registered trademark) PD-7 and CATIOMASTER PD-30 (both manufactured by Yokkaichi Chemical Co., Ltd.) and UNISENCE FPA100L (manufactured by Senka Corporation).

The content of the aggregating agent (D) is not particularly limited.

From the viewpoint of the aggregation rate of the ink, the content of the aggregating agent (D) is preferably in a range of 0.1% by mass to 40% by mass, more preferably in a range of 0.1% by mass to 30% by mass, still more preferably in a range of 1% by mass to 20% by mass, and particularly preferably in a range of 1% by mass to 10% by mass with respect to the total amount of the pretreatment liquid.

From the viewpoint of further suppressing image bleeding, it is preferable that the aggregating agent (D) preferably contains an organic acid.

In a case where the aggregating agent contains an organic acid, the preferable ranges of the content of the organic acid with respect to the total amount of the pretreatment liquid are also the same as the above-described preferable ranges of the content of the aggregating agent (D) with respect to the total amount of the pretreatment liquid.

In a case where the aggregating agent (D) contains an organic acid, the proportion of the organic acid in the total amount of the aggregating agent (D) is preferably in a range of 50% by mass to 100% by mass, more preferably in a range of 80% by mass to 100% by mass, and still more preferably in a range of 90% by mass to 100% by mass.

<Water (E)>

The pretreatment liquid contains water (E).

That is, the pretreatment liquid is a so-called aqueous liquid.

The content of water (E) is preferably 50% by mass or greater and more preferably 60% by mass or greater with respect to the total amount of the pretreatment liquid.

The upper limit of the content of water (E) is appropriately determined according to the content of other components. The upper limit of the content of water (A) with respect to the total amount of the pretreatment liquid may be 90% by mass, 80% by mass, or the like.

<Resin Particles>

The pretreatment liquid may contain resin particles. In a case where the pretreatment liquid contains resin particles, an image with excellent adhesiveness can be obtained.

The glass transition temperature (Tg) of the resin particles contained in the pretreatment liquid is preferably in a range of 30° C. to 120° C., more preferably in a range of 30° C. to 80° C., still more preferably in a range of 40° C. to 60° C., and even still more preferably in a range of 45 to 60° C.

The method of measuring the glass transition temperature of the resin particles is as described above.

Examples of the resin in the resin particles include a polyurethane resin, a polyamide resin, a polyurea resin, a polycarbonate resin, a polyolefin resin, a polystyrene resin, a polyester resin, and an acrylic resin. Among these, the resin particles contain preferably a polyester resin or an acrylic resin and more preferably a polyester resin.

Further, acrylic resin particles, polyester resin particles, a mixture of acrylic resin particles and polyester resin particles, or composite particles containing an acrylic resin and a polyester resin are preferable as the resin particles.

The resin in the resin particles has preferably an alicyclic structure or an aromatic ring structure and more preferably an aromatic ring structure.

As the alicyclic structure, an alicyclic hydrocarbon structure having 5 to 10 carbon atoms is preferable, and a cyclohexane ring structure, a dicyclopentanyl ring structure, a dicyclopentenyl ring structure, or an adamantane ring structure is preferable.

As the aromatic ring structure, a naphthalene ring or a benzene ring is preferable, and a benzene ring is more preferable.

The amount of the alicyclic structure or the aromatic ring structure is, for example, preferably in a range of 0.01 mol to 1.5 mol and more preferably in a range of 0.1 mol to 1 mol per 100 g of the specific resin.

From the viewpoint that the particles containing the specific resin are preferably used as water-dispersible resin particles described below, it is preferable that the resin in the resin particles contains an ionic group in the structure.

The ionic group may be an anionic group or a cationic group, but an anionic group is preferable from the viewpoint of ease of introduction.

The anionic group is not particularly limited, but a carboxy group or a sulfo group is preferable, and a sulfo group is more preferable.

The amount of the ionic group is not particularly limited, and an amount of the ionic group set such that the particles containing the specific resin are water-dispersible resin particles can be preferably used. For example, the amount thereof is preferably in a range of 0.001 mol to 1.0 mol and more preferably in a range of 0.01 mol to 0.5 mol, per 100 g of the resin contained in the particles containing the specific resin.

The weight-average molecular weight (Mw) of the resin in the resin particles is preferably in a range of 1000 to 300000, more preferably in a range of 2000 to 200000, and still more preferably in a range of 5000 to 100000.

It is preferable that the resin particles are water-dispersible resin particles.

In the present disclosure, the water dispersibility indicates a property in which precipitation is not confirmed after a substance is stirred in water at 20° C. and the solution is allowed to stand at 20° C. for 60 minutes.

The volume average particle diameter of the resin particles is preferably in a range of 1 nm to 300 nm, more preferably in a range of 3 nm to 200 nm, and still more preferably in a range of 5 nm to 150 nm.

Further, as the resin particles, the same resin particles as those in the specific ink described above may be used.

In a case of preparing the pretreatment liquid, a commercially available product of an aqueous dispersion liquid of resin particles may be used.

Examples of the commercially available product of an aqueous dispersion liquid of resin particles include PESRESIN A124GP, PESRESIN A645GH, PESRESIN A615GE, and PESRESIN A520 (all manufactured by Takamatsu Oil & Fat Co., Ltd.), Eastek 1100 and Eastek 1200 (both manufactured by Eastman Chemical Company), PLASCOAT RZ570, PLASCOAT Z687, PLASCOAT Z565, PLASCOAT RZ570, and PLASCOAT Z690 (all manufactured by Goo Chemical Co., Ltd.), VYLONAL MD1200 (manufactured by Toyobo Co., Ltd.), and EM57DOC (manufactured by Daicel FineChem Ltd.).

The content of resin particles is not particularly limited.

The content of the resin particles is preferably in a range of 0.5% by mass to 30% by mass, more preferably in a range of 1% by mass to 20% by mass, and particularly preferably in a range of 1% by mass to 15% by mass with respect to the total amount of the pretreatment liquid.

<Water-Soluble Organic Solvent>

It is preferable that the pretreatment liquid contains at least one water-soluble organic solvent.

As the water-soluble organic solvent, known solvents can be used without particular limitation.

Examples of the water-soluble organic solvent include polyhydric alcohol such as glycerin, 1,2,6-hexanetriol, trimethylolpropane, alkanediol (for example, ethylene glycol, propylene glycol (1,2-propanediol), 1,3-propanediol, 1,3-butanediol, 1,4-butanediol, 2-butene-1,4-diol, 2-ethyl-1,3-hexanediol, 2-methyl-2,4-pentanediol, 1,2-octanediol, 1,2-hexanediol, 1,2-pentanediol, or 4-methyl-1,2-pentanediol), or polyalkylene glycol (for example, diethylene glycol, triethylene glycol, tetraethylene glycol, pentaethylene glycol, dipropylene glycol, or polyoxyethylene polyoxypropylene glycol); polyhydric alcohol ether such as polyalkylene glycol ether (for example, diethylene glycol monoalkyl ether, triethylene glycol monoalkyl ether, tripropylene glycol monoalkyl ether, or polyoxypropylene glyceryl ether); and saccharides, sugar alcohols, hyaluronic acids, alkyl alcohols having 1 to 4 carbon atoms, glycol ethers, 2-pyrrolidone, and N-methyl-2-pyrrolidone described in paragraph 0116 of JP2011-42150A.

Among these, from the viewpoint of suppressing transfer of components, polyhydric alcohol or polyhydric alcohol ether is preferable, and alkanediol, polyalkylene glycol, or polyalkylene glycol ether is more preferable.

The content of the water-soluble organic solvent is not particularly limited.

The content of the water-soluble organic solvent is preferably in a range of 0.5% by mass to 30% by mass, more preferably in a range of 1% by mass to 20% by mass, and particularly preferably in a range of 1% by mass to 15% by mass with respect to the total amount of the pretreatment liquid.

<Surfactant>

The pretreatment liquid may contain at least one surfactant.

The surfactant can be used as a surface tension adjuster or an antifoaming agent. Examples of the surface tension adjuster or the antifoaming agent include a non-ionic surfactant, a cationic surfactant, an anionic surfactant, and a betaine surfactant. Among these, from the viewpoint of the aggregation rate of the ink, a non-ionic surfactant or an anionic surfactant is preferable.

Examples of the surfactant include compounds exemplified as surfactants in pp. 37 and 38 of JP1984-157636A (JP-S59-157636A) and Research Disclosure No. 308119 (1989). Further, other examples of the surfactant include fluorine-based (fluorinated alkyl-based) surfactants and silicone-based surfactants described in JP2003-322926A, JP2004-325707A, and JP2004-309806A.

For example, in a case where the pretreatment liquid contains a surfactant as an antifoaming agent, the content of the surfactant as an antifoaming agent is preferably in a range of 0.0001% by mass to 1% by mass and more preferably in a range of 0.001% by mass to 0.1% by mass with respect to the total amount of the pretreatment liquid.

<Other Components>

The pretreatment liquid may contain other components in addition to the above-described components as necessary.

Examples of other components that may be contained in the pretreatment liquid include known additives such as a solid wetting agent, colloidal silica, an inorganic salt, a fading inhibitor, an emulsion stabilizer, a penetration enhancer, an ultraviolet absorbing agent, a preservative, a fungicide, a pH adjuster, a viscosity adjuster, a rust inhibitor, a chelating agent, and a water-soluble polymer compound other than a water-soluble cationic polymer (for example, water-soluble polymer compounds described in paragraphs 0026 to 0080 of JP2013-001854A).

<Physical Properties of Pretreatment Liquid>

From the viewpoint of the aggregation rate of the ink, the pH of the pretreatment liquid at 25° C. is preferably in a range of 0.1 to 3.5.

In a case where the pH of the pretreatment liquid is 0.1 or greater, the roughness of the impermeable base material is further decreased and the adhesiveness of the image area is further improved.

In a case where the pH of the pretreatment liquid is 3.5 or less, the aggregation rate is further improved, coalescence of dots (ink dots) caused by the ink on the surface of the impermeable base material is further suppressed, and the roughness of the image is further decreased.

The pH of the pretreatment liquid at 25° C. is more preferably in a range of 0.2 to 2.0. The conditions for measuring the pH of the pretreatment liquid at 25° C. are the same as the conditions for measuring the pH of the ink at 25° C. described above.

In the case where the pretreatment liquid contains an aggregating agent, from the viewpoint of the aggregation rate of the ink, the viscosity of the pretreatment liquid is preferably in a range of 0.5 mPa·s to 10 mPa·s and more preferably in a range of 1 mPa·s to 5 mPa·s. The conditions for measuring the viscosity of the pretreatment liquid here are the same as the conditions for measuring the viscosity of the ink described above.

The surface tension of the pretreatment liquid at 25° C. is preferably 60 mN/m or less, more preferably in a range of 20 mN/m to 50 mN/m, and still more preferably in a range of 30 mN/m to 45 mN/m. The conditions for measuring the surface tension of the pretreatment liquid here are the same as the conditions for measuring the surface tension of the ink described above.

[Base Material]

The base material in the image forming method of the present disclosure is not particularly limited, and a known base material can be used.

Examples of the base material include a paper base material, a paper base material on which a resin (such as polyethylene, polypropylene, or polystyrene) is laminated, a resin base material, a metal plate (such as a plate made of a metal such as aluminum, zinc, or copper), a paper base material on which the above-described metal is laminated or vapor-deposited, and a resin base material on which the above-described metal is laminated or vapor-deposited.

Further, examples of the base material also include a textile base material.

Examples of the material of the textile base material include natural fibers such as cotton, silk, hemp, and wool; chemical fibers such as viscose rayon and lyocell; synthetic fibers such as polyester, polyamide, and acryl; and a mixture of at least two selected from the group consisting of natural fibers, chemical fibers, and synthetic fibers. As the textile base material, the textile base material described in paragraphs [0039] to <0042> of WO2015/158592A may be used.

As the base material, an impermeable base material is preferable.

The impermeable base material indicates a base material having a water absorption rate (% by mass, 24 hr.) of less than 0.2 according to ASTMD 570 of the ASTM test method.

The impermeable base material is not particularly limited, but a resin base material is preferable.

The resin base material is not particularly limited, and examples thereof include a thermoplastic resin base material.

Examples of the resin base material include a base material obtained by molding a thermoplastic resin in the form of a sheet or film.

As the resin base material, a base material containing polypropylene, polyethylene terephthalate, nylon, polyethylene, or polyimide is preferable.

The resin base material may be a transparent resin base material or a colored resin base material.

Here, the term “transparent” indicates that the transmittance of visible light having a wavelength of 400 nm to 700 nm is 80% or greater (preferably 90% or greater).

The shape of the resin base material is not particularly limited, but a sheet-shaped resin base material is preferable, and a sheet-shaped resin base material which is capable of forming a roll by being wound is more preferable.

The thickness of the resin base material is preferably in a range of 10 μm to 200 μm and more preferably in a range of 10 μm to 100 μm.

The resin base material may be subjected to a surface treatment from the viewpoint of improving the surface energy.

Examples of the surface treatment include a corona treatment, a plasma treatment, a flame treatment, a heat treatment, an abrasion treatment, a light irradiation treatment (UV treatment), and a flame treatment, but the present invention is not limited thereto.

[Pretreatment Liquid Adding Step]

The pretreatment liquid adding step is a step of applying the above-described pretreatment liquid onto the base material.

The application of the pretreatment liquid onto the base material can be performed by applying a known method such as a coating method, an ink jet method, or a dipping method.

Examples of the coating method include known coating methods using a bar coater (such as a wire bar coater), an extrusion die coater, an air doctor coater, a blade coater, a rod coater, a knife coater, a squeeze coater, a reserve roll coater, a gravure coater, or a flexo coater.

The details of the ink jet method are the same as the details of the ink jet method which can be applied to an image forming step described below.

The amount of the pretreatment liquid to be applied (specifically, the number of grams (g/m²) of the pretreatment liquid to be applied per area of 1 m²) is appropriately adjusted.

The amount of the pretreatment liquid to be applied may be adjusted to be in a range where Expression (2) (that is, 0.10≤C_{C}/C_{D}≤2.90) is satisfied in consideration of, for example, the number of grams (g/m²) of the ink to be applied per area of 1 m² described below, the proportion (% by mass) of the organic solvent (C) in the ink, and the proportion (% by mass) of the aggregating agent (D) in the pretreatment liquid.

The number of grams (g/m²) of the pretreatment liquid to be applied per area of 1 m² is preferably in a range of 0.1 g/m² to 10 g/m², more preferably in a range of 0.5 g/m² to 6.0 g/m², still more preferably in a range of 0.8 g/m² to 2.0 g/m², and even still more preferably in a range of 1.2 g/m² to 1.6 g/m².

In a case where the number of grams (g/m²) of the pretreatment liquid to be applied is in the above-described preferable range, Expression (2) (that is, 0.10≤C_{C}/C_{D}≤2.90) is likely to be satisfied.

Here, the number of grams (g/m²) of the pretreatment liquid to be applied is an amount of the pretreatment liquid to be applied, which is converted into the number of grams thereof to be applied per area of 1 m². Therefore, it goes without saying that the area where the pretreatment liquid is actually applied (that is, the area of the image) in a case where the base material is viewed in a plan view may be less than 1 m².

In the pretreatment liquid adding step, the base material may be heated before the application of the pretreatment liquid.

The heating temperature is set such that the temperature of the base material is preferably in a range of 20° C. to 50° C. and more preferably in a range of 25° C. to 40° C.

In the pretreatment liquid adding step, the pretreatment liquid may be heated and dried after the application of the pretreatment liquid and before the image forming step described above.

Examples of the means for heating and drying the pretreatment liquid include known heating means such as a heater, known air blowing means such as a dryer, and means for combining these.

Examples of the method of heating and drying the pretreatment liquid include a method of applying heat using a heater or the like from a side of the base material opposite to the surface onto which the pretreatment liquid has been applied; a method of applying warm air or hot air to the surface of the base material onto which the pretreatment liquid has been applied; a method of applying heat using an infrared heater from the surface of the base material onto which the pretreatment liquid has been applied or from a side of the base material opposite to the surface onto which the pretreatment liquid has been applied; and a method of combining a plurality of these methods.

The heating temperature of heating and drying the pretreatment liquid is preferably 35° C. or higher and more preferably 40° C. or higher.

The upper limit of the heating temperature is not particularly limited, and the upper limit thereof is preferably 100° C., more preferably 90° C., and still more preferably 70° C.

The time of heating and drying the treatment liquid is not particularly limited, but is preferably in a range of 0.5 seconds to 60 seconds, more preferably in a range of 0.5 seconds to 20 seconds, and particularly preferably in a range of 0.5 seconds to 10 seconds.

[Image Forming Step]

The image forming step is a step of applying the specific ink using an ink jet method onto the pretreatment liquid applied onto the base material to form an image.

The amount of the specific ink to be applied (specifically, the number of grams (g/m²) of the specific ink to be applied per area of 1 m²) is appropriately adjusted.

The amount of the specific ink to be applied may be adjusted to be in a range where Expression (2) (that is, 0.10≤C_{C}/C_{D}≤2.90) is satisfied in consideration of, for example, the number of grams (g/m²) of the pretreatment liquid to be applied per area of 1 m² described above, the proportion (% by mass) of the organic solvent (C) in the ink, and the proportion (% by mass) of the aggregating agent (D) in the pretreatment liquid.

The number of grams (g/m²) of the specific ink to be applied per area of 1 m² is preferably in a range of 0.1 g/m² to 10 g/m², more preferably in a range of 0.5 g/m² to 6.0 g/m², still more preferably in a range of 0.8 g/m² to 2.0 g/m², and even still more preferably in a range of 1.2 g/m² to 1.6 g/m².

In a case where the number of grams (g/m²) of the specific ink to be applied is in the above-described preferable range, Expression (2) (that is, 0.10≤C_{C}/C_{D}≤2.90) is likely to be satisfied.

Here, the number of grams (g/m²) of the specific ink to be applied is an amount of the specific ink to be applied, in terms of the number of grams thereof to be applied per area of 1 m². Therefore, it goes without saying that the area where the specific ink is actually applied (that is, the area of the image) in a case where the base material is viewed in a plan view may be less than 1 m².

In the present disclosure, the application of the specific ink onto the pretreatment liquid applied onto the base material using an ink jet method indicates that the specific ink is applied onto the pretreatment liquid by allowing the specific ink to be jetted from the ink jet head.

As the method of allowing the specific ink to be jetted from the ink jet head, for example, an electric charge control method of allowing an ink to be jetted using an electrostatic attraction force; a drop-on-demand method (pressure pulse method) using a vibration pressure of a piezoelectric element; an acoustic ink jet method of allowing an ink to be jetted using a radiation pressure by converting an electric signal into an acoustic beam and irradiating the ink with the acoustic beam; and a thermal ink jet (bubble jet (registered trademark)) method of heating an ink to form air bubbles and utilizing the generated pressure can be used.

Further, as the method of allowing the specific ink to be jetted from the ink jet head, for example, a method described in JP1979-59936A (JP-S54-59936A), in which an ink is jetted from a nozzle using an action force caused by a rapid change in volume of the ink after being subjected to an action of thermal energy can also be used.

Further, as the method of allowing the ink to be jetted from the ink jet head, a method described in paragraphs 0093 to 0105 of JP2003-306623A can also be used.

Examples of the system of the ink jet head include a shuttle system of performing recording while scanning a short serial head in the width direction of a base material serving as a medium to be recorded and a line system of using a line head in which recording elements are aligned in correspondence with the entire area of one side of a base material.

In the line system, image formation can be performed on the entire surface of the base material by scanning the base material in a direction intersecting the direction in which the recording elements are aligned. In the line system, a transport system such as a carriage that scans a short head in the shuttle system is not necessary. Further, in the line system, since the movement of a carriage and complicated scanning control between the head and the base material are not necessary as compared with the shuttle system, only the base material moves. Therefore, according to the line system, image formation at a higher speed than that of the shuttle system is realized.

It is preferable that the application of the specific ink is performed using an ink jet head having a resolution of 300 dpi or greater (more preferably 600 dpi and still more preferably 800 dpi). Here, dpi stands for dot per inch, and 1 inch is 2.54 cm.

From the viewpoint of obtaining a high-definition image, the liquid droplet amount of the specific ink to be jetted from the nozzle of the ink jet head is preferably in a range of 1 pL (pico liter) to 10 pL and more preferably in a range of 1.5 pL to 6 pL.

Further, from the viewpoints of improving the image unevenness and improving connection of continuous gradations, it is also effective that the ink is jetted by combining different amounts of liquid droplets.

In the image forming step, an image may be obtained by heating and drying the specific ink applied onto the base material.

Examples of the means for heating and drying the ink include known heating means such as a heater, known air blowing means such as a dryer, and means for combining these.

Examples of the method for heating and drying the specific ink include a method of applying heat using a heater or the like from a side of the base material opposite to the surface onto which the specific ink has been applied; a method of applying warm air or hot air to the surface of the base material onto which the specific ink has been applied; a method of applying heat using an infrared heater from the surface of the base material onto which the specific ink has been applied or from a side of the base material opposite to the surface onto which the specific ink has been applied; and a method of combining a plurality of these methods.

The heating temperature of heating and drying the ink is preferably 55° C. or higher, more preferably 60° C. or higher, and particularly preferably 65° C. or higher. The upper limit of the heating temperature is not particularly limited, and the upper limit thereof may be 100° C. and preferably 90° C.

The time of heating and drying the specific ink is not particularly limited, but is preferably in a range of 3 seconds to 60 seconds, more preferably in a range of 5 seconds to 60 seconds, and particularly preferably in a range of 10 seconds to 45 seconds.

Further, the base material may be heated in advance before the application of the specific ink.

The heating temperature may be appropriately set, but the temperature of the base material is set to be preferably in a range of 20° C. to 50° C. and more preferably in a range of 25° C. to 40° C.

In the image forming step, an image may be formed by applying two or more kinds of inks corresponding to the specific ink. As the two or more kinds of inks in this case, for example, a first ink containing a white inorganic pigment and a second ink containing a colorant of a color other than white without containing a white inorganic pigment can be used. As a more specific embodiment of this case, first, an embodiment in which a pretreatment liquid is applied onto a transparent resin base material serving as a base material, an image of characters, figures, and the like is recorded by the second ink, and an image (for example, a solid image) is recorded by the first ink so as to cover the image recorded by the second ink and an image non-forming area of the base material is exemplified. In this case, the image of characters, figures, and the like recorded by the second ink is visually recognized through the base material from the side of the rear surface (that is, the surface on the side opposite to the surface where the image is formed) of the base material.

Further, the image forming method of the present disclosure may include the image forming step (hereinafter, also referred to as a “first image forming step”) using the specific ink and a second image forming step using an ink that does not correspond to the specific ink.

As a specific embodiment in this case, an embodiment in which an ink A containing a white inorganic pigment is used as the specific ink and an ink B containing a colorant of a color other than white without containing a white inorganic pigment is used as the ink that does not correspond to the specific ink is exemplified. As a more specific embodiment in this case, first, an embodiment in which an image of characters, figures, and the like is recorded by the ink B on a transparent resin base material serving as a base material by performing the pretreatment liquid adding step and the second image forming step, and an image (for example, a solid image) is recorded by the ink A so as to cover the image recorded by the second ink and the image non-forming area of the base material by performing the first image forming step is exemplified. In this case, the image of characters, figures, and the like recorded by the ink B is visually recognized through the base material from the side of the rear surface (that is, the surface on the side opposite to the surface where the image is formed) of the base material.

It is preferable to use an aqueous ink as the ink B, similar to the ink A. Specific examples of the ink B include an ink which is the same as the specific ink except that the ink does not contain the white inorganic pigment and the organic solvent (C).

[Expression (2)]

In the image forming method of the present disclosure, in a region (that is, a region where an image has been formed) to which the specific ink has been applied in a case where the base material to which the specific ink has been applied is viewed in a plan view, C_{C}(g/m²) which the number of grams of the organic solvent (C) to be applied per area of 1 m² and C_{D} (g/m²) which is the number of grams of the aggregating agent (D) to be applied per area of 1 m² satisfy Expression (2).

0.10≤C_{C}/C_{D}≤2.90 Expression (2)

C_{C} and C_{D} represent the amounts of the organic solvent (C) to be applied and the amount of the aggregating agent (D) to be applied, respectively, in terms of the number of grams thereof to be applied per area of 1 m².

Therefore, it goes without saying that the area where the ink is actually applied (that is, the area of the image) in a case where the base material is viewed in a plan view may be less than 1 m².

Expression (2) indicates that C_{C}/C_{D} is 0.10 or greater and 2.90 or less.

In a case where C_{C}/C_{D} is 0.10 or greater, image bleeding is suppressed. From the viewpoint of further suppressing image bleeding, C_{C}/C_{D} is preferably 0.30 or greater, more preferably 0.50 or greater, still more preferably 0.80 or greater, even still more preferably 1.00 or greater, and even still more preferably 1.50 or greater.

In a case where the C_{C}/C_{D} is 2.90 or less, image cracking is suppressed. From the viewpoint of further suppressing image cracking, C_{C}/C_{D} is preferably 2.50 or less, more preferably 2.30 or less, and still more preferably 2.00 or less.

As one of the preferred embodiments, an embodiment in which C_{C}/C_{D} is 0.50 or greater and 2.00 or less is exemplified.

C_{C}/C_{D} is determined based on the number of grams (g/m²) of the specific ink to be applied per area of 1 m², the proportion (that is, the content; % by mass) of the organic solvent (C) in the ink, the proportion (that is, the content; % by mass) of the aggregating agent (D) in the pretreatment liquid, and the number of grams (g/m²) of the pretreatment liquid to be applied per area of 1 m².

The image forming method of the present disclosure is not particularly limited as long as C_{C}/C_{D} satisfies Expression (2).

Preferred examples of the method for allowing C_{C}/C_{D} to satisfy Expression (2) include a method (hereinafter, also referred to as a method A) of determining the number of grams (g/m²) of the specific ink to be applied per area of 1 m² and determining the number of grams (g/m²) of the pretreatment liquid to be applied per area of 1 m² to be in a range where Expression (2) is satisfied based on the proportion (that is, the content; % by mass) of the organic solvent (C) in the ink and the proportion (that is, the content; % by mass) of the aggregating agent (D) in the pretreatment liquid on the premise of the determined number of grams (g/m²) of the specific ink to be applied; and a method (hereinafter, also referred to as a method B) of determining the number of grams (g/m²) of the pretreatment liquid to be applied per area of 1 m² and determining the number of grams (g/m²) of the specific ink to be applied per area of 1 m² to be in a range where Expression (2) is satisfied based on the proportion (that is, the content; % by mass) of the organic solvent (C) in the ink and the proportion (that is, the content; % by mass) of the aggregating agent (D) in the pretreatment liquid on the premise of the determined number of grams (g/m²) of the pretreatment liquid to be applied.

The method A is preferable in terms of having an advantage that the number of grams of the specific ink to be applied is not restricted, and the method B is preferable in terms of having an advantage that the number of grams of the pretreatment liquid to be applied is not restricted.

The image forming method of the present disclosure in a case where the above-described method A is applied includes a determining step A of determining the number of grams (g/m²) of the specific ink to be applied per area of 1 m², and a determining step B of determining the number of grams (g/m²) of the pretreatment liquid to be applied per area of 1 m² to be in a range where Expression (2) is satisfied, based on the number of grams (g/m²) of the specific ink to be applied which has been determined in the determining step A, the proportion of the organic solvent (C) in the specific ink, and the proportion of the aggregating agent (D) in the pretreatment liquid.

In this case, the pretreatment liquid is applied onto the base material in the pretreatment liquid adding step based on the number of grams (g/m²) of the pretreatment liquid to be applied which has been determined in the determining step B, and the specific ink is applied onto the pretreatment liquid applied onto the base material to form an image in the image forming step based on the number of grams (g/m²) of the specific ink to be applied which has been determined in the determining step A.

In the determining step A, the number of grams (g/m²) of the specific ink to be applied is optionally determined.

For example, the number of grams (g/m²) of the specific ink to be applied is determined as the amount of the specific ink to be applied which corresponds to the density of the image to be formed by the specific ink. Specifically, for example, the relationship between the density of the image and the number of grams of the specific ink to be applied is investigated by conducting a preliminary experiment. Based on the obtained relationships, the number of grams of the specific ink to be applied which corresponds to the density of the required image is determined.

The step order in a case where the image forming method of the present disclosure includes the determining step A and the determining step B is not particularly limited.

The timing of the determining step A is not particularly limited as long as the determining step A is provided before the image forming step.

The timing of the determining step B is not particularly limited as long as the determining step B is provided before the pretreatment liquid adding step.

The image forming method of the present disclosure in a case where the above-described method B is applied includes a determining step X of determining the number of grams (g/m²) of the pretreatment liquid to be applied per area of 1 m², and a determining step Y of determining the number of grams (g/m²) of the specific ink to be applied per area of 1 m² to be in a range where Expression (2) is satisfied, based on the number of grams (g/m²) of the pretreatment liquid to be applied which has been determined in the determining step X, the proportion of the organic solvent (C) in the specific ink, and the proportion of the aggregating agent (D) in the pretreatment liquid.

In this case, the pretreatment liquid is applied onto the base material in the pretreatment liquid adding step based on the number of grams (g/m²) of the pretreatment liquid to be applied which has been determined in the determining step X, and the specific ink is applied onto the pretreatment liquid applied onto the base material to form an image in the image forming step based on the number of grams (g/m²) of the specific ink to be applied which has been determined in the determining step Y.

In the determining step X, the number of grams (g/m²) of the pretreatment liquid to be applied is optionally determined.

For example, the number of grams (g/m²) of the pretreatment liquid to be applied is determined in consideration of the restriction of a device in a case of using an image forming device, the stability of the pretreatment liquid adding process, and the like.

The step order in a case where the image forming method of the present disclosure includes the determining step X and the determining step Y is not particularly limited.

The timing of the determining step Y is not particularly limited as long as the determining step Y is provided before the image forming step.

The timing of the determining step X is not particularly limited as long as the determining step X is provided before the pretreatment liquid adding step.

In the image forming method of the present disclosure, C_{C} (g/m²) which is the number of grams of the organic solvent (C) to be applied per area of 1 m² is preferably in a range of 0.00005 g/m² to 1.2 g/m², more preferably in a range of 0.0005 g/m² to 0.6 g/m², still more preferably in a range of 0.004 g/m² to 0.30 g/m², and even still more preferably in a range of 0.012 g/m² to 0.20 g/m².

Further, in the image forming method of the present disclosure, C_{D} (g/m²) which is the number of grams of the aggregating agent (D) to be applied per area of 1 m² is preferably in a range of 0.00001 g/m² to 4 g/m², more preferably in a range of 0.0005 g/m² to 1.8 g/m², still more preferably in a range of 0.008 g/m² to 0.4 g/m², and even still more preferably in a range of 0.012 g/m² to 0.16 g/m².

### Examples

Hereinafter, examples of the present disclosure will be described below, but the present disclosure is not limited to the following examples.

In the description below, “water” indicates ion exchange water unless otherwise specified.

<Preparation of Aqueous Dispersion Liquid of Resin Particles or Aqueous Solution of Resin>

As described below, an aqueous dispersion liquid of acryl 1, an aqueous dispersion liquid of urethane 1, and an aqueous dispersion liquid of polyester 1 were prepared as aqueous dispersion liquids of resin particles, and an aqueous solution of acryl 2 was prepared as an aqueous solution of a resin.

Here, the resins particles (that is, the acryl 1, the urethane 1, and the polyester 1) are resin particles formed of main resins in the resin (B), and the acryl 2 is a main resin (non-particles) in the resin (B).

The SP values (SP_{B}) of the main resins in the resin (B) are as listed in Tables 1 and 2.

(Preparation of Aqueous Dispersion Liquid of Acryl 1)

The aqueous dispersion liquid of the acryl 1 was prepared as follows.

A 2 L three-neck flask (reaction container) provided with a stirrer, a thermometer, a reflux condenser, and a nitrogen gas introduction pipe was charged with 560.0 g of methyl ethyl ketone, and the solution was heated to 87° C. Next, a mixed solution formed of 220.4 g of methyl methacrylate, 301.6 g of isobornyl methacrylate, 58.0 g of methacrylic acid, 108 g of methyl ethyl ketone, and 2.32 g of “V-601” (polymerization initiator, manufactured by FUJIFILM Wako Pure Chemical Corporation, dimethyl 2,2′-azobis(2-methyl propionate)) was added dropwise to the methyl ethyl ketone in the reaction container at a constant speed such that the dropwise addition was completed for 2 hours while the reflux state in the reaction container was maintained (hereinafter, the reflux state was maintained until the reaction was completed). After completion of the dropwise addition, the solution was stirred for 1 hour, and the operation of the following step (1) was performed on the solution after being stirred for 1 hour.

Step (1) . . . A solution formed of 1.16 g of “V-601” and 6.4 g of methyl ethyl ketone was added to the solution, and the resulting solution was stirred for 2 hours.

Next, the operation of the step (1) was repeatedly performed four times, a solution formed of 1.16 g of “V-601” and 6.4 g of methyl ethyl ketone was added to the solution, and the resulting solution was stirred for 3 hours (the operation carried out so far is referred to as the “reaction”).

After completion of the reaction, the temperature of the solution was lowered to 65° C., 163.0 g of isopropanol was added thereto, and the solution was allowed to be naturally cooled, thereby obtaining a polymerization solution containing a copolymer (concentration of solid contents of 41.0% by mass).

Next, 317.3 g of the obtained polymerization solution was weighed, 46.4 g of isopropanol, 1.65 g of a 20% maleic acid anhydride aqueous solution (water-soluble acidic compound, corresponding to 0.3% by mass as maleic acid with respect to the copolymer), and 40.77 g of a 2 mol/L sodium hydroxide (NaOH) aqueous solution were added to the solution, and the temperature of the liquid in the reaction container was increased to 70° C.

Next, 380 g of distilled water was added dropwise to the liquid which had been heated to 70° C., at a speed of 10 mL/min, to carry out dispersion in water (dispersion step).

Thereafter, a total amount of 287.0 g of isopropanol, methyl ethyl ketone, and distilled water was distilled off by maintaining the temperature of the liquid in the reaction container at 70° C. for 1.5 hours under reduced pressure (solvent removal step). 0.278 g (440 mass ppm as benzisothiazolin-3-one as the solid content of the polymer) of PROXEL GXL (S) (manufactured by Arch Chemicals, Inc.) was added to the obtained liquid.

The obtained liquid was filtered through a filter with a pore size of 1 μm, and the filtrate was collected, thereby obtaining an aqueous dispersion liquid of the acryl 1 (nonvolatile content concentration of 23.2% by mass) as resin particles formed of a copolymer of methyl methacrylate, isobornyl methacrylate, methacrylic acid, and sodium methacrylate at a mass ratio of 70/20/5/5. The volume average particle diameter of the acryl 1 was 5.0 nm, and the weight-average molecular weight (Mw) of the acryl 1 was 60000.

(Preparation of Aqueous Solution of Acryl 2)

As an aqueous solution of the acryl 2 which is an acrylic resin, “ARON A-20L”, (manufactured by Toagosei Co., Ltd., Mw=500000) was prepared.

(Preparation of Aqueous Dispersion Liquid of Urethane 1)

As the aqueous dispersion liquid of the urethane 1, a urethane emulsion “WBR-2101” (nonvolatile content concentration of 27% by mass) (manufactured by Taisei Fine Chemical Co., Ltd.) was prepared.

(Preparation of Aqueous Dispersion Liquid of Polyester 1)

As the aqueous dispersion liquid of the polyester 1, a polyester emulsion “WR-961” (nonvolatile content concentration of 30% by mass) (manufactured by Nippon Synthetic Chemical Industry Co., Ltd.) was prepared.

<Preparation of Titanium Dioxide (TiO₂) Aqueous Dispersion Liquid>

(Synthesis of Pigment Dispersion Resin P-1 (Dispersant))

In the following manner, a pigment dispersion resin P-1 for dispersing titanium dioxide (TiO₂) in water was synthesized.

Here, the pigment dispersion resin P-1 (dispersant) is a resin other than the main resins in the resin (B).

The same mass of dipropylene glycol as the total amount of monomers described below was added to a three-neck flask equipped with a stirrer and a condenser and heated to 85° C. in a nitrogen atmosphere.

A solution I obtained by mixing 9.1 molar equivalents of stearyl methacrylate, 34.0 molar equivalents of benzyl methacrylate, 31.9 molar equivalents of hydroxyethyl methacrylate, 25.0 molar equivalents of methacrylic acid, and 0.8 molar equivalents of 2-mercaptopropionic acid and a solution II obtained by dissolving 1% by mass of t-butylperoxy-2-ethylhexanoate (Perbutyl 0, manufactured by NOF Corporation) with respect to the total amount of the monomers in 20% by mass of dipropylene glycol with respect to the total amount of the monomers were respectively prepared. The solution I was added dropwise to the three-neck flask for 4 hours, and the solution II was added dropwise thereto for 5 hours.

After the completion of the dropwise addition, the resulting solution was allowed to further react for 2 hours, heated to 95° C., and heated and stirred for 3 hours so that all unreacted monomers were allowed to react. The disappearance of monomers was confirmed by the nuclear magnetic resonance (¹H-NMR) method.

The obtained reaction solution was heated to 70° C., 20.0 molar equivalents of dimethylethanolamine was added thereto as an amine compound, propylene glycol was added thereto, and the resulting solution was stirred, thereby obtaining a 30 mass % solution of the pigment dispersion resin P-1.

The constituent components of the obtained polymer were confirmed by ¹H-NMR. Further, the weight-average molecular weight (Mw) determined by GPC was 22000.

Further, the mass ratio of respective constitutional units in the pigment dispersion resin P-1 (constitutional unit derived from stearyl methacrylate/constitutional unit derived from benzyl methacrylate/constitutional unit derived from hydroxyethyl methacrylate/constitutional unit derived from methacrylic acid) was 20/39/27/14. Here, the mass ratio does not include the mass of dimethylaminoethanol.

(Preparation of Titanium Dioxide (TiO₂) Aqueous Dispersion Liquid)

A TiO₂ dispersion liquid was prepared in the following manner using a Lady Mill model LSG-4U-08 (manufactured by AIMEX Co., Ltd.).

That is, 45 parts by mass of titanium dioxide (TiO₂; average primary particle diameter: 210 nm, trade name: PF-690, manufactured by Ishihara Sangyo Kaisha, Ltd.; white inorganic pigment), 15 parts by mass of a 30 mass % solution of the pigment dispersion resin P-1, and 40 parts by mass of ultrapure water were added to a zirconia container. Further, 40 parts by mass of 0.5 mmφ zirconia beads (Torayceram beads, manufactured by Toray Industries, Inc.) were added thereto and mixed gently using a spatula. The zirconia container having the obtained mixture was put into a ball mill and dispersed at a rotation speed of 1000 rpm (revolutions per minute) for 5 hours. After the dispersion was completed, the beads were removed by filtration with a filter cloth, thereby preparing a TiO₂ dispersion liquid having a TiO₂ concentration of 45% by mass.

### Example 1

<Preparation of Ink>

An ink with the following composition was prepared using the aqueous dispersion liquid of the acryl 1, the titanium dioxide (TiO₂) aqueous dispersion liquid, propylene glycol monobutyl ether (PGmBE) as an organic solvent (C), propylene glycol (a boiling point of 188° C. and an SP value of 35.1 MPa^{1/2}) as an organic solvent (F), and water.

The prepared ink is a white ink containing titanium dioxide (TiO₂) which is a white inorganic pigment as a colorant.

Ink Composition
Acryl 1 [resin particles formed of main resin in resin (B)] . . . 6.0% by mass
Propylene glycol monobutyl ether (PGmBE) [organic solvent (C)] . . . 1.0% by mass
Propylene glycol (PG) [organic solvent (F)] . . . 27% by mass
Titanium dioxide (TiO₂) [colorant (E)] . . . 5.0% by mass
Pigment dispersion resin P-1 [resin other than main resins in resin (B)] . . . 0.5% by mass
Water . . . remaining amount set such that total amount of composition was 100% by mass

<Preparation of Pretreatment Liquid>

A pretreatment liquid having the following composition was prepared.

Composition of pretreatment liquid
Eastek (registered trademark) 1100 (manufactured by Eastman Chemical Company) [polyester resin particles] . . . 10% by mass in terms of amount of resin particles (solid content)
Glutaric acid (manufactured by Fujifilm Wako Pure Chemical Corporation) [aggregating agent] . . . 4.10% by mass
Propylene glycol (manufactured by Fujifilm Wako Pure Chemical Corporation) [water-soluble organic solvent] . . . 10% by mass
Water . . . remaining amount set such that total amount was 100% by mass

<Image Formation>

Images were formed in the following manner using the ink and the pretreatment liquid.

A GELJET (registered trademark) GX5000 printer head (manufactured by Ricoh Co., Ltd.) was prepared as an ink jet head. The printer head is a line head in which 96 nozzles are arranged.

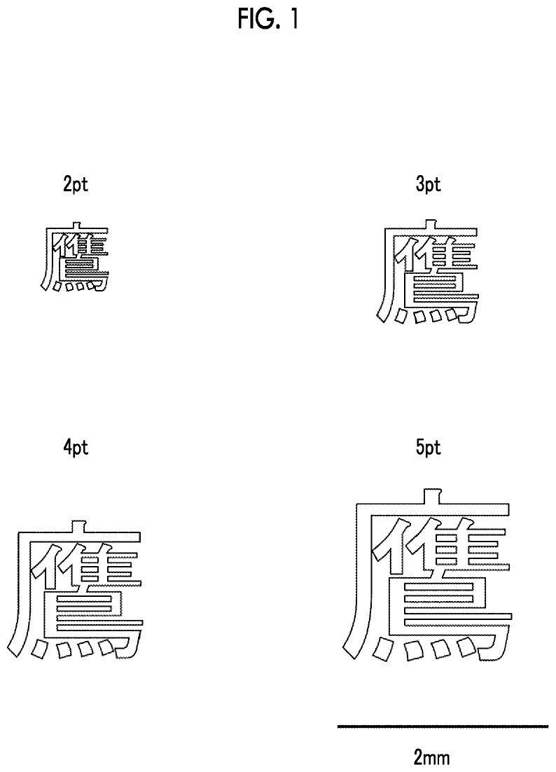

The printer head was fixedly disposed in an ink jet recording device having the same configuration as that of the ink jet recording device illustrated in FIG. 1 described above.

The disposition here was made such that the direction in which 96 nozzles were arranged was inclined by 75.7° with respect to a direction orthogonal to a movement direction of a stage of an ink jet device on the same plane.

A liquid-repellent film containing a fluorine compound is provided on the ink jetted surface of the line head.

The liquid-repellent film containing a fluorine compound is a monolayer (SAM film) of C₈F₁₇C₂H₄SiCl₃.

A polyethylene terephthalate (PET) base material (FE2001, thickness of 12 μm, manufactured by Futamura Chemical Co., Ltd.) (impermeable base material) was prepared as a base material, and the pretreatment liquid adding step and the image forming step were sequentially performed using the PET base material.

(Pretreatment Liquid Adding Step)

The base material was fixed onto the stage of the ink jet recording device, and the pretreatment liquid was applied onto the base material using a wire bar coater while the stage onto which the base material had been fixed was allowed to move in a linear direction at a constant speed of 500 mm/sec. The amount of the pretreatment liquid applied (that is, the number of grams thereof applied per area of 1 m²) was set to 1.5 g/m².

The drying of the pretreatment liquid was started at a site where the application of the pretreatment liquid was completed, under a temperature condition of 50° C. using a dryer 1.5 seconds after the completion of the application of the pretreatment liquid to the site, and the drying was completed 3.5 seconds after the completion of the application of the pretreatment liquid. The drying time here was 2 seconds.

(Image Forming Step)

The ink was allowed to be jetted to the surface of the base material, onto which the pretreatment liquid had been applied, from the printer head according to the line system while the base material after the drying of the pretreatment liquid had been completed was allowed to move at a constant stage speed of 50 mm/sec. As a result, the ink was applied in the form of a solid image. The amount of the ink applied (that is, the number of grams thereof applied per area of 1 m²) was 10.4 g/m².

The jetting of the ink was started within 2 seconds from the completion of drying of the pretreatment liquid.

The ink was allowed to be jetted under the conditions of an ink droplet amount of 4.5 pL, a jetting frequency of 24 kHz, and a resolution of 1200 dpi×1200 dpi (dot per inch).

Further, an ink which was degassed through a degassing filter and in which the temperature thereof was adjusted to 30° C. was used as the ink.

Next, the ink applied onto the surface of the base material onto which the pretreatment liquid had been applied was dried at 70° C. for 10 seconds to obtain an image (specifically, a solid image).

As described above, an image forming product comprising a base material and an image disposed on the base material was obtained.

Table 1 shows C_{C}/C_{D} in the region (that is, the image) to which the ink was applied.

Here, C_{C} represents the number of grams (g/m²) of the organic solvent (C) applied per area of 1 m², C_{D} represents the number of grams (g/m²) of the aggregating agent (D) applied per area of 1 m², and C_{C}/C_{D} represents the ratio of C_{C} to C_{D}.

<Evaluation>

The following evaluation was carried out using the above-described ink.

The results are listed in Table 1.

(Image Bleeding)

Character images (unicode: U+9DF9; 2pt, 3pt, 4pt, and 5pt) shown in FIG. 1 were obtained by performing image formation in the same manner as described above except that the ink was applied in the form of a character image. Here, pt indicates the DTP point representing the font size, and 1 pt is 1/72 inch.

The obtained character images were observed, and image bleeding was evaluated based on the following evaluation standards.

The results are listed in Table 1.

In the following evaluation standards, the rank in which image bleeding was most suppressed is set as “AA”.

Evaluation Standards for Image Bleeding

AA: Characters with a size of 2 pt were able to be reproduced.

A: Characters with a size of 3 pt were able to be reproduced, but characters with a size of 2 pt were not able to be reproduced.

B: Characters with a size of 4 pt were able to be reproduced, but characters with a size of 3 pt or less were not able to be reproduced.

C: Characters with a size of 5 pt were able to be reproduced, but characters with a size of 4 pt or less were not able to be reproduced.

D: Characters with a size of 5 pt were not able to be reproduced.

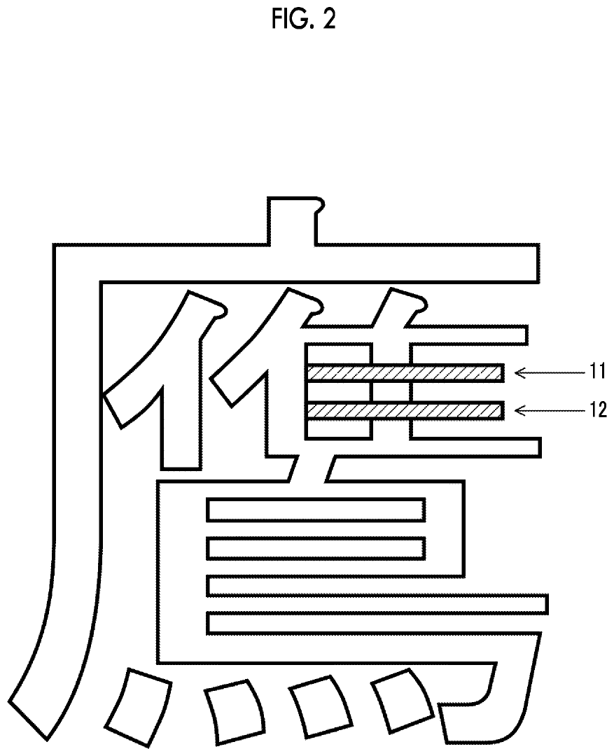

The expression of “was able to be reproduced” means that the horizontal line indicated by the reference numeral 11 in FIG. 2 and the horizontal line indicated by the reference numeral 12 in FIG. 2 are separated from each other in the character image of FIG. 1 as confirmed at a position separated by 0.5 m.

(Image Cracking)

In the solid image, occurrence of image cracking was confirmed by setting a region having an area of 50 mm (the transport direction of the base material)×20 mm (a direction orthogonal to the transport direction of the base material) as an “image cracking evaluation region” and visually observing the image cracking evaluation in the solid image. More specifically, in the “image cracking evaluation region”, the number of cracks in the image increased before and after the ink was dried (at 70° C. for 10 seconds) in the image formation was counted.

Based on the confirmed results, image cracking was evaluated based on the following evaluation standards.

The results are listed in Table 1.

In the following evaluation standards, the rank in which the image cracking was most suppressed is set as “AA”.

Evaluation Standards for Image Cracking

AA: The number of cracks in the image increased before and after the drying was 0.

A: The number of cracks in the image increased before and after the drying was 1 or 2.

B: The number of cracks in the image increased before and after the drying was in a range of 3 to 5.

C: The number of cracks in the image increased before and after the drying was in a range of 6 to 10.

D: The number of cracks in the image increased before and after the drying was 11 or greater.

(Image Streaks)

A region having an area of 50 mm (the transport direction of the base material)×20 mm (a direction orthogonal to the transport direction of the base material) in the solid image was set as a “streak evaluation region”.

The streak evaluation region in the solid image was visually observed, occurrence of streaks in parallel with the transport direction of the base material and the degree of the occurrence were confirmed, and the streaks of the image was evaluated based on the following evaluation standards.

The results are listed in Table 1.

In the following evaluation standards, the rank in which the streaks of the image were most suppressed is set as “A”.

Further, in the following evaluation standards, the streaks which were able to be easily visually recognized indicate streaks which were able to be visually recognized in a case of being observed at a position separated by 50 cm.

Evaluation Standards for Streaks in Image

A: The occurrence of streaks was not visually recognized in the solid image.

B: One extremely thin streak was visually recognized in the solid image (streak unevenness which was able to be easily visually recognized was not confirmed).

C: Two or more extremely thin streaks were visually recognized in the solid image (streak unevenness which was able to be easily visually recognized was not confirmed).

D: One streak which was able to be easily visually recognized was confirmed in the solid image.

E: Two or more streaks which were easily visually recognized were confirmed in the solid image.

### Examples 2 to 21

The same operation as in Example 1 was performed except that a combination of the kind of the main resin in the resin (B), the content of the main resin in the resin (B), the content of the dispersant, the kind of the organic solvent (C), and the content of the organic solvent (C) in the ink was changed as listed in Table 1.

In the examples in which the content of the organic solvent (C) was changed, the amount of the ink applied was adjusted such that C_{C}/C_{D} was set to the value listed in Table 1.

The results are listed in Table 1.

### Examples 22 to 26

The same operation as in Example 1 was performed except that a combination of the kind of the aggregating agent (D) and the content of the aggregating agent (D) in the pretreatment liquid was changed as listed in Table 1.

In the examples in which the content of the aggregating agent (D) was changed, the amount of the pretreatment liquid applied was adjusted such that C_{C}/C_{D} was set to the value listed in Table 1.

The results are listed in Table 1.

### Examples 27 to 30

The same operation as in Example 1 was performed except that the amount of the ink applied was changed such that C_{C}/C_{D} was set to the value listed in Table 2.

The results are listed in Table 2.

### Examples 31 to 34

The same operation as in Example 1 was performed except that the content of the resin (B) (the main resin and the dispersant) in the ink was changed.

The results are listed in Table 2.

### Examples 35 and 36

The same operation as in Example 1 was performed except that the kind of the main resin in the resin (B) of the ink was changed as listed in Table 2.

The results are listed in Table 2.

### Comparative Examples 1 and 2

The same operation as in Example 1 was performed except that a combination of the content of the main resin in the resin (B), the kind of the organic solvent (C), and the content of the organic solvent (C) in the ink, and the kind and content of the aggregating agent (D) in the pretreatment liquid was changed as listed in Table 2 and the amount of the ink applied was changed so that C_{C}/C_{D} was adjusted to the value listed in Table 2.

The results are listed in Table 2.

### Comparative Example 3

The same operation as in Example 1 was performed except that the organic solvent (C) was changed to 1,2-BDO (1,2-butanediol), which is a comparative solvent.

The results are listed in Table 2.

### Comparative Examples 4 and 5

The same operation as in Example 1 was performed except that the amount of the ink applied was changed such that C_{C}/C_{D} was set to the value listed in Table 2.

The results are listed in Table 2.

TABLE 1

| | Ink | | | | | | | |
|---|---|---|---|---|---|---|---|---|
| | Resin (B) | | | | | | | |
| | Main resin | | | | Organic solvent (C) | | | |
| | | SP value | | Dispersant | | SP value | | |
| | Type | (SP_{B}) | Amount | Amount | Type | (SP_{c}) | Amount | \|SP_{C} − SP_{B}\| |
| Example 1 | Acryl 1 | 19.7 | 6.0% | 0.5% | PGmBE | 21.1 | 1.0% | 1.4 |
| Example 2 | Acryl 1 | 19.7 | 6.0% | 0.5% | 2-EH | 19.7 | 1.0% | 0.0 |
| Example 3 | Acryl 1 | 19.7 | 6.0% | 0.5% | 1-H | 20.7 | 1.0% | 1.0 |
| Example 4 | Acryl 1 | 19.7 | 6.0% | 0.5% | 1-O | 19.8 | 1.0% | 0.1 |
| Example 5 | Acryl 1 | 19.7 | 6.0% | 0.5% | DPGmME | 22.1 | 1.0% | 2.4 |
| Example 6 | Acryl 1 | 19.7 | 6.0% | 0.5% | TEGmBE | 21.4 | 1.0% | 1.7 |
| Example 7 | Acryl 1 | 19.7 | 6.0% | 0.5% | PGmPE | 21.7 | 1.0% | 2.0 |
| Example 8 | Acryl 1 | 19.7 | 6.0% | 0.5% | PGmME | 23.6 | 1.0% | 3.9 |
| Example 9 | Acryl 1 | 19.7 | 6.0% | 0.5% | DMAE | 23.7 | 1.0% | 4.0 |
| Example 10 | Acryl 2 | 20.2 | 6.0% | 0.5% | PGmBE | 21.1 | 1.0% | 0.9 |
| | (non-particle) | | | | | | | |
| Example 11 | Acryl 1 | 19.7 | 6.0% | 0.5% | PGmBE | 21.1 | 0.05% | 1.4 |
| Example 12 | Acryl 1 | 19.7 | 6.0% | 0.5% | PGmBE | 21.1 | 0.10% | 1.4 |
| Example 13 | Acryl 1 | 19.7 | 6.0% | 0.5% | PGmBE | 21.1 | 5.0% | 1.4 |
| Example 14 | Acryl 1 | 19.7 | 6.0% | 0.5% | PGmBE | 21.1 | 10.0% | 1.4 |
| Example 15 | Acryl 1 | 19.7 | 6.0% | 0.5% | PGmBE | 21.1 | 12.0% | 1.4 |
| Example 16 | Acryl 1 | 19.7 | 0.6% | 0.06% | PGmBE | 21.1 | 1.0% | 1.4 |
| Example 17 | Acryl 1 | 19.7 | 1.0% | 0.08% | PGmBE | 21.1 | 1.0% | 1.4 |
| Example 18 | Acryl 1 | 19.7 | 10.0% | 0.9% | PGmBE | 21.1 | 1.0% | 1.4 |
| Example 19 | Acryl 1 | 19.7 | 14.0% | 1.2% | PGmBE | 21.1 | 1.0% | 1.4 |
| Example 20 | Acryl 1 | 19.7 | 6.0% | 0.5% | 1,2-HDO | 27.2 | 1.0% | 7.5 |
| Example 21 | Acryl 1 | 19.7 | 6.0% | 0.5% | 1,2-PDO | 29.0 | 1.0% | 9.3 |
| Example 22 | Acryl 1 | 19.7 | 6.0% | 0.5% | PGmBE | 21.1 | 1.0% | 1.4 |
| Example 23 | Acryl 1 | 19.7 | 6.0% | 0.5% | PGmBE | 21.1 | 1.0% | 1.4 |
| Example 24 | Acryl 1 | 19.7 | 6.0% | 0.5% | PGmBE | 21.1 | 1.0% | 1.4 |
| Example 25 | Acryl 1 | 19.7 | 6.0% | 0.5% | PGmBE | 21.1 | 1.0% | 1.4 |
| Example 26 | Acryl 1 | 19.7 | 6.0% | 0.5% | PGmBE | 21.1 | 1.0% | 1.4 |

| | Ink | | | | | | |
|---|---|---|---|---|---|---|---|
| | Content mass | Pretreatment liquid | | | Evaluation result | | |
| | ratio | Aggregating agent (D) | | | Image | Image | |
| | [C/B] | Type | Amount | C_{C}/C_{D} | bleeding | cracking | Streak |
| Example 1 | 0.15 | Glutaric acid | 4.1% | 1.70 | AA | AA | A |
| Example 2 | 0.15 | Glutaric acid | 4.1% | 1.70 | AA | AA | A |
| Example 3 | 0.15 | Glutaric acid | 4.1% | 1.70 | AA | AA | A |
| Example 4 | 0.15 | Glutaric acid | 4.1% | 1.70 | AA | AA | A |
| Example 5 | 0.15 | Glutaric acid | 4.1% | 1.70 | AA | AA | A |
| Example 6 | 0.15 | Glutaric acid | 4.1% | 1.70 | AA | AA | A |
| Example 7 | 0.15 | Glutaric acid | 4.1% | 1.70 | AA | AA | A |
| Example 8 | 0.15 | Glutaric acid | 4.1% | 1.70 | A | AA | A |
| Example 9 | 0.15 | Glutaric acid | 4.1% | 1.70 | A | AA | A |
| Example 10 | 0.15 | Glutaric acid | 4.1% | 1.70 | B | AA | A |
| Example 11 | 0.01 | Glutaric acid | 4.1% | 1.70 | B | AA | C |
| Example 12 | 0.02 | Glutaric acid | 4.1% | 1.70 | A | AA | C |
| Example 13 | 0.77 | Glutaric acid | 4.1% | 1.70 | AA | AA | A |
| Example 14 | 1.54 | Glutaric acid | 4.1% | 1.70 | AA | A | A |
| Example 15 | 1.85 | Glutaric acid | 4.1% | 1.70 | AA | B | A |
| Example 16 | 1.52 | Glutaric acid | 4.1% | 1.70 | AA | A | A |
| Example 17 | 0.93 | Glutaric acid | 4.1% | 1.70 | AA | AA | A |
| Example 18 | 0.09 | Glutaric acid | 4.1% | 1.70 | A | AA | A |
| Example 19 | 0.07 | Glutaric acid | 4.1% | 1.70 | B | AA | B |
| Example 20 | 0.15 | Glutaric acid | 4.1% | 1.70 | B | AA | A |
| Example 21 | 0.15 | Glutaric acid | 4.1% | 1.70 | C | AA | A |
| Example 22 | 0.15 | Malonic acid | 4.1% | 1.70 | AA | AA | A |
| Example 23 | 0.15 | Potassium citrate | 4.1% | 1.70 | AA | AA | A |
| Example 24 | 0.15 | Ca nitrate | 4.1% | 1.70 | A | AA | A |
| Example 25 | 0.15 | Al sulfate | 2.7% | 1.70 | A | AA | A |
| Example 26 | 0.15 | Cationic polymer 1 | 4.1% | 1.70 | A | AA | A |

TABLE 2

| | Ink | | | | | | | |
|---|---|---|---|---|---|---|---|---|
| | Resin (B) | | | | | | | |
| | Main resin | | | | Organic solvent (C) or comparative solvent | | | |
| | | SP value | | Dispersant | | SP value | | |
| | Type | (SP_{B}) | Amount | Amount | Type | (SP_{c}) | Amount | \|SP_{C} − SP_{B}\| |
| Example 27 | Acryl 1 | 19.7 | 6.0% | 0.5% | PGmBE | 21.1 | 1.0% | 1.4 |
| Example 28 | Acryl 1 | 19.7 | 6.0% | 0.5% | PGmBE | 21.1 | 1.0% | 1.4 |
| Example 29 | Acryl 1 | 19.7 | 6.0% | 0.5% | PGmBE | 21.1 | 1.0% | 1.4 |
| Example 30 | Acryl 1 | 19.7 | 6.0% | 0.5% | PGmBE | 21.1 | 1.0% | 1.4 |
| Example 31 | Acryl 1 | 19.7 | 24.0% | 2.0% | PGmBE | 21.1 | 1.0% | 1.4 |
| Example 32 | Acryl 1 | 19.7 | 3.0% | 0.25% | PGmBE | 21.1 | 1.0% | 1.4 |
| Example 33 | Acryl 1 | 19.7 | 1.0% | 0.08% | PGmBE | 21.1 | 1.0% | 1.4 |
| Example 34 | Acryl 1 | 19.7 | 12.0% | 1.0% | PGmBE | 21.1 | 1.0% | 1.4 |
| Example 35 | Acryl 1 | 19.1 | 6.0% | 0.5% | PGmBE | 21.1 | 1.0% | 2.0 |
| Example 36 | Polyester 1 | 18.3 | 6.0% | 0.5% | PGmBE | 21.1 | 1.0% | 2.8 |
| Comparative | Acryl 1 | 19.7 | 3.0% | 0.25% | 1,2-HDO | 27.1 | 5.0% | 7.4 |
| Example 1 | | | | | | | | |
| Comparative | Acryl 1 | 19.7 | 19.0% | 1.6% | 1,2-HDO | 27.1 | 5.0% | 7.4 |
| Example 2 | | | | | | | | |
| Comparative | Acryl 1 | 19.7 | 6.0% | 0.5% | 1,2-BDO | 31.4 | 1.0% | 11.7 |
| Example 3 | | | | | | | | |
| Comparative | Acryl 1 | 19.7 | 19.0% | 1.6% | PGmBE | 21.1 | 1.0% | 1.4 |
| Example 4 | | | | | | | | |
| Comparative | Acryl 1 | 19.7 | 19.0% | 1.6% | PGmBE | 21.1 | 1.0% | 1.4 |
| Example 5 | | | | | | | | |

| | Ink | | | | | | |
|---|---|---|---|---|---|---|---|
| | Content | Pretreatment liquid | | | Evaluation result | | |
| | mass ratio | Aggregating agent (D) | | | Image | Image | |
| | [C/B] | Type | Amount | C_{C}/C_{D} | bleeding | cracking | Streak |
| Example 27 | 0.15 | Glutaric acid | 4.1% | 0.31 | B | AA | A |
| Example 28 | 0.15 | Glutaric acid | 4.1% | 0.85 | A | AA | A |
| Example 29 | 0.15 | Glutaric acid | 4.1% | 1.90 | AA | A | A |
| Example 30 | 0.15 | Glutaric acid | 4.1% | 2.30 | AA | B | A |
| Example 31 | 0.04 | Glutaric acid | 4.1% | 1.70 | A | AA | C |
| Example 32 | 0.31 | Glutaric acid | 4.1% | 1.70 | AA | A | A |
| Example 33 | 0.93 | Glutaric acid | 4.1% | 1.70 | A | A | A |
| Example 34 | 0.08 | Glutaric acid | 4.1% | 1.70 | A | AA | C |
| Example 35 | 0.15 | Glutaric acid | 4.1% | 1.70 | AA | AA | A |
| Example 36 | 0.15 | Glutaric acid | 4.1% | 1.70 | AA | AA | A |
| Comparative | 1.54 | Mg sulfate | 6.0% | 2.93 | D | C | A |
| Example 1 | | | | | | | |
| Comparative | 0.24 | Mg sulfate | 6.0% | 2.93 | A | C | D |
| Example 2 | | | | | | | |
| Comparative | 0.15 | Glutaric acid | 4.1% | 1.70 | D | AA | A |
| Example 3 | | | | | | | |
| Comparative | 0.05 | Glutaric acid | 4.1% | 2.93 | A | C | D |
| Example 4 | | | | | | | |
| Comparative | 0.05 | Glutaric acid | 4.1% | 0.04 | D | AA | D |
| Example 5 | | | | | | | |

Explanation of Table 1 and Table 2
The “amount” in each component of the ink indicates the content (% by mass) with respect to the total amount of the ink.
The “amount” of the aggregating agent (D) in the pretreatment liquid indicates the content (% by mass) with respect to the total amount of the pretreatment liquid.
The content mass ratio [C/B] indicates the ratio of the content mass of the organic solvent (C) to the content mass of the resin (B) in the ink.
The unit of the SP value is MPa^{1/2}.
Since water, the colorant (E), and the organic solvent (F) in the ink are components common to all the examples, the notation is not provided in Tables 1 and 2.
Since water, the water-soluble organic solvent, and the resin particles in the pretreatment liquid are components common to all the examples, the notation is not provided in Tables 1 and 2.

### Abbreviations for Organic Solvents in Tables 1 and 2

PGmBE: propylene glycol monobutyl ether
2-EH: 2-ethyl hexanol
1-H: 1-hexanol
1-O: 1-octanol
DPGmME: dipropylene glycol monomethyl ether
TEGmBE: triethylene glycol monobutyl ether
PGmPE: propylene glycol monopropyl ether
PGmME: propylene glycol monomethyl ether
DMAE: dimethylaminoethanol
1,2-HDO: 1,2-hexanediol
1,2-PDO: 1,2-pentanediol
1,2-BDO: 1,2-butanediol

Aggregating agents in Tables 1 and 2
Glutaric acid: glutaric acid (manufactured by Fujifilm Wako Pure Chemical Corporation)
Malonic acid: malonic acid (manufactured by Fujifilm Wako Pure Chemical Corporation)
Ca nitrate: calcium nitrate (manufactured by Fujifilm Wako Pure Chemical Corporation)
Al nitrate: aluminum nitrate (manufactured by Fujifilm Wako Pure Chemical Corporation)
Cationic polymer 1: dimethyldiallylammonium chloride (“SHALLOL DC-902P”, manufactured by DKS Co., Ltd.)
Mg sulfate: magnesium sulfate (manufactured by Fujifilm Wako Pure Chemical Corporation)

As listed in Tables 1 and 2, in each example in which the image forming method including a step of preparing an ink containing water (A), a resin (B), and an organic solvent (C) satisfying Expression (1) (that is, “|SP_{C}−SP_{B}|≤10.0”), a step of preparing a pretreatment liquid containing an aggregating agent (D) and water (E), a step of applying the pretreatment liquid onto a base material; and a step of applying the ink using an ink jet method onto the pretreatment liquid applied onto the base material to form an image satisfying Expression (2) (that is, “0.10≤C_{C}/C_{D}≤2.90”) was performed, image bleeding and image cracking were suppressed.

The results of the comparative examples with respect to each example were as follows (see Table 2).

In Comparative Examples 1, 2, and 4 in which C_{C}/C_{D} was greater than 2.00, image cracking occurred.

In Comparative Example 5 in which C_{C}/C_{D} was less than 0.10, image bleeding occurred.

In Comparative Example 3 in which a comparative solvent (1,2-BDO) that did not satisfy Expression (1) (that is, “|SP_{C}—SP_{B}|≤10.0”) was used in place of the organic solvent (C), image bleeding occurred.

As shown in the results of Examples 1 to 9, 20, and 21, it was found that in a case where the organic solvent (C) contained an organic solvent in which |SP_{C}—SP_{B}| was 5.0 or less (Examples 1 to 9), image bleeding was further suppressed.

As shown in the results of Examples 1, 27, and 28, it was found that in a case where C_{C}/C_{D} was 0.50 or greater (Examples 1 and 28), image bleeding was further suppressed.

As shown in the results of Examples 1, 29, and 30, it was found that in a case where C_{C}/C_{D} was 2.00 or less (Examples 1 and 29), image cracking was further suppressed.

As shown in the results of Examples 11 to 15, it was found that in a case where the content of the organic solvent (C) in the ink was 0.10% by mass or greater (Examples 12 to 15), image bleeding was further suppressed.

As shown in the results of Examples 11 to 15, it was found that in a case where the content of the organic solvent (C) in the ink was 10.0% by mass or less (Examples 11 to 14), image cracking was further suppressed.

As shown in the results of Examples 1 and 10, it was found that in a case where the resin (B) in the ink contained resin particles (Example 1), image bleeding was further suppressed.

As shown in the results of Examples 11 to 15, it was found that in a case where the content mass ratio [C/B] was 0.02 or greater (Examples 12 to 15), image bleeding was further suppressed.

As shown in the results of Examples 11 to 15, it was found that in a case where the content mass ratio [C/B] was 1.00 or less (Examples 11 to 13), image cracking was further suppressed.

As described above, the examples using a white ink containing a white pigment as a colorant have been described as examples.

It goes without saying that even in a case where the colorant is changed to a colorant other than the white pigment (for example, a cyan pigment, a magenta pigment, a yellow pigment, or a black pigment) in the ink of each example described above, the same effects as those of each example can be obtained.

What is claimed is:

1. An image forming method comprising:
a step of preparing an ink containing water (A), a resin (B), and an organic solvent (C) that satisfies Expression (1);
a step of preparing a pretreatment liquid containing an aggregating agent (D) and water (E);
a step of applying the pretreatment liquid onto a base material; and
a step of forming an image by applying the ink using an ink jet method onto the pretreatment liquid applied onto the base material,
wherein in a region to which the ink has been applied, in a case where the base material to which the ink has been applied is viewed in a plan view, C_{C} which is the number of grams of the organic solvent (C) to be applied per area of 1 m² and C_{D} which is the number of grams of the aggregating agent (D) to be applied per area of 1 m² satisfy Expression (2),

|SP_{C}−SP_{B}|≤10.0 Expression (1)
0.10≤C_{C}/C_{D}≤2.90 Expression (2)
in Expression (1), SP_{B} represents an SP value of a main resin in the resin (B) in a unit of MPa^{1/2}, SP_{C} represents an SP value of the organic solvent (C) in the unit of MPa^{1/2}, and |SP_{C}−SP_{B}| represents an absolute value of a difference between SP_{C} and SP_{B}.

2. The image forming method according to claim 1,
wherein the aggregating agent (D) contains at least one selected from the group consisting of a polyvalent metal compound, an organic acid, a polyvalent metal salt, and a water-soluble cationic polymer.

3. The image forming method according to claim 1,
wherein in a case of the organic solvent (C), |SP_{C}−SP_{B}| is 5.0 or less.

4. The image forming method according to claim 1,
wherein the C_{C}/C_{D} in Expression (2) is 0.50 or greater and 2.00 or less.

5. The image forming method according to claim 1,
wherein a content of the organic solvent (C) in the ink is in a range of 0.10% by mass to 10.0% by mass with respect to a total amount of the ink.

6. The image forming method according to claim 1,
wherein the resin (B) in the ink contains resin particles.

7. The image forming method according to claim 1,
wherein a ratio of a content mass of the organic solvent (C) to a content mass of the resin (B) in the ink is 0.02 or greater and 1.00 or less.

8. The image forming method according to claim 1,
wherein the ink further contains an organic solvent other than the organic solvent (C).

9. The image forming method according to claim 1,
wherein the base material is an impermeable base material.

10. The image forming method according to claim 1, further comprising:
a determining step A of determining the number of grams of the ink to be applied per area of 1 m²; and
a determining step B of determining the number of grams of the pretreatment liquid to be applied per area of 1 m² to be in a range where Expression (2) is satisfied, based on the number of grams of the ink to be applied which has been determined in the determining step A, a proportion of the organic solvent (C) in the ink, and a proportion of the aggregating agent (D) in the pretreatment liquid,
wherein the step of applying the pretreatment liquid is a step of applying the pretreatment liquid onto the base material based on the number of grams of the pretreatment liquid to be applied which has been determined in the determining step B, and
the step of forming an image is a step of forming an image by applying the ink onto the pretreatment liquid applied onto the base material based on the number of grams of the ink to be applied which has been determined in the determining step A.
